(19) United States
(12) Patent Application Publication
(10) Pub. No.: US 2026/0130559 A1
(43) Pub. Date: May 14, 2026

(54) STATION FOR ROBOT CLEANER

(71) Applicant: LG ELECTRONICS INC., Seoul (KR)

(72) Inventors: Kookhaeng LEE, Seoul (KR); Jungwan RYU, Seoul (KR); Sungjun KIM, Seoul (KR)

(73) Assignee: LG ELECTRONICS INC., Seoul (KR)

(21) Appl. No.: 19/384,520

(22) Filed: Nov. 10, 2025

(30) Foreign Application Priority Data
Nov. 12, 2024 (KR) 10-2024-0160008

(51) Int. Cl. A47L 11/40; B08B 3/04; A47B 88/00

(52) U.S. Cl. CPC A47L 11/4091; B08B 3/04; A47B 88/00; A47L 2201/022; A47L 2201/028

(57) ABSTRACT

There is disclosed a robot cleaner station including a housing comprising a pair of outer walls facing each other; a mop washing unit disposed within the housing, and configured to wash a mop of a robot cleaner; and a fitting portion disposed on a side of the housing, and the mop washing unit may include a wash water nozzle configured to discharge water for washing the mop; a wastewater inlet configured to suck in water used for washing the mop, and the fitting portion may be connected to the wash water nozzle and the wastewater inlet.

This application claims priority to and the benefit of Korean Patent Application No. 10-2024-0160008 filed on 2024.11.12, the disclosure of which is incorporated herein by reference in its entirety.

### BACKGROUND

### Technical Field

Embodiments of the present disclosure relate to a station for a robot cleaner, more particularly, a built-in robot cleaner station that may collect dust from a robot cleaner's dustbin, wash a robot cleaner's mop, and dry the mop, when coupled to the robot cleaner.

### Background of the Disclosure

With recent advancement of industrial technology, robot cleaners (or robot cleaners) are being developed that can move around and clean areas required to be cleaned without user intervention.

Such a robot cleaner includes a sensor configured to recognize the space to be cleaned, an agitator configured to sweep and clean the floor, and a mop configured to wipe the floor, and may move while sucking up dust on the floor in the space recognized by the sensor and wiping it with the mop, etc.

Robot cleaners are classified into dry robot cleaners that can suck up and remove foreign substances scattered on the floor, and wet robot cleaner that can wipe out the floor with a moist mop to effectively remove foreign substances attached to the floor. Such a dry robot cleaner is provided with a dust bin and configured to suck up foreign substances on the floor by using the suction power of a suction motor. Such a wet robot cleaner is provided with a water tank and the water contained in the water tank is supplied to a mop so that the mop can wipe out the floor while containing moisture, effectively removing foreign substances attached to the floor.

Charging stands of robot cleaner stations are devices where a robot cleaner having finished cleaning is docked and power is supplied to a battery installed in the robot cleaner to charge the battery. The charging stand may include a power supply module inside. The charging stand includes a charging terminal connected to the power supply module, and the robot cleaner includes a corresponding terminal. When the charging terminal and the corresponding terminal make contact, power is supplied to the battery and it is charged.

Meanwhile, if the robot cleaner station is placed inside a building, it will occupy a certain area of the indoor space. In this case, the indoor space efficiency might be deteriorated. In addition, there is a risk that a user or pet might collide with the robot cleaner while passing by, resulting in injury to the user or pet as well as damage to the robot cleaner.

In the case of a station with an added dust collection function for a robot cleaner, there is a limit to how much damage it can do to the interior of a room due to the increased volume it occupies.

Meanwhile, CN 218922468 U discloses a cleaner station in which a robot cleaner is connected with the lower part of a washing machine to charge the robot cleaner, collect dust, and wash the mop of the robot cleaner.

However, the above-mentioned cleaner station has an open space formed at the bottom of the washing machine into which a robot cleaner can enter, a detergent and water supply mechanism for washing a mop is provided at a vertical upper side of the space into which the robot cleaner enters. A dust bag is placed on the side of the space into which the robot cleaner enters.

In this arrangement, the overall height of the cleaner station is high so that there is a limitation in that it cannot be installed using the space underneath the furniture, including the sink.

In addition, since the above-mentioned cleaner station must be installed at the bottom of the washing machine, a space for installing the washing machine must be provided. There is a limit in that an installation space with a height exceeding the heigh of the cleaner station must be provided, considering not only the height of the cleaner station but also the height of the washing machine itself.

Meanwhile, Chinese Utility Model Registration No. CN 219846382 U discloses a cleaner station that is coupled to the lower part of a washing machine, and that charges a robot cleaner, collects dust, and washes the robot cleaner's mop.

The cleaner station includes a water storage box and a detergent box for cleaning the mop. Furthermore, the water storage box and detergent box are configured to be removable.

However, the cleaner station has the limitation that the water storage box and detergent box must be replaced periodically when their contents are exhausted.

### DETAILED DESCRIPTION OF THE INVENTION

### Technical Problem

Accordingly, one object of the present disclosure is to solve the above-noted disadvantages of the prior art, and to provide a robot cleaner station that may be built into the bottom of a kitchen cabinet without requiring a separate installation space.

Another object of the present disclosure is to provide a robot cleaner station that may accommodate a robot cleaner in the lower space of a kitchen cabinet with a certain height restriction.

A further object of the present disclosure is to provide a robot cleaner station that may automatically collect dust inside a robot cleaner's dust bin, when combined with a robot cleaner, when coupled to the robot cleaner.

A still further object of the present disclosure is to provide a cleaner station that may automatically clean the robot cleaner's mop, when coupled to the robot cleaner.

A still further object of the present disclosure is to provide a cleaner station that may automatically dry the mop after washing it.

A still further object of the present disclosure is to provide a cleaner station that may be pulled out for cleaning and repair as needed.

A still further object of the present disclosure is to provide a cleaner station that may prevent dust from scattering outside, when collecting dust of the robot cleaner.

A still further object of the present disclosure is to provide a robot cleaner station that may prevent waste water from leaking outside, when washing the mop of the robot cleaner.

A still further object of the present disclosure is to provide a robot cleaner station with a water supply or drainage path structure that may maximize the installation efficiency of the robot cleaner station.

### Technical Solution

To solve the objects of the present disclosure, a robot cleaner station may include a housing comprising a pair of outer walls facing each other; a mop washing unit disposed within the housing, and configured to wash a mop of a robot cleaner; and a fitting portion disposed on a side of the housing, and the mop washing unit may include a wash water nozzle configured to discharge water for washing the mop; a wastewater inlet configured to suck in water used for washing the mop, and the fitting portion is connected to the wash water nozzle and the wastewater inlet.

In addition, the outer wall may include a left outer wall positioned on the left; and a right outer wall positioned on the right, when looking forward from inside the robot cleaner station, with the direction in which the robot cleaner is introduced being forward. The fitting portion may be formed one on each of the left outer wall and the right outer wall, and the wash water nozzle and the wastewater inlet may be selectively connected to one of the pair of fitting portions.

The robot cleaner station may further include a flow path connection module through which water supplied to the wash water nozzle and water sucked into the wastewater inlet pass, respectively; a water supply connection pipe configured to supply water from an external water source to the flow path connection module; and a drain connection pipe through which water discharged from the flow path connection module passes. The water supply connection pipe and the drain connection pipe may be pivotally connected to the flow path connection module.

The water supply connection pipe and the drain connection pipe may be detachably connected to one of the pair of fitting portions.

The diameter of the drain connection pipe may be larger than the diameter of the water supply connection pipe.

The mop washing unit may include an elbow fitting having a bent shape and configured to change the direction of internal fluid flow, and the elbow fitting may have on one end pivotally connected to the flow path connection module, and the other end positioned so as to face the left or right outer wall of the housing.

The robot cleaner station may further include a power supply terminal disposed within the housing and coupled to the robot cleaner and configured to supply power; a power line configured to supply power to the power supply terminal from the outside, and the power line may be detachably connected to one of the pair of fitting portions.

Each of the pair of fitting portions may include a water supply connection pipe coupling portion to which the water supply connection pipe is coupled, a drain connection pipe coupling portion to which the drain connection pipe is coupled, and a power connection to which the power line is connected.

The robot cleaner station may further include a drawer that drawn out from the housing and comprising a mounting unit on which the robot cleaner is mounted, and wherein the drawer may be coupled to the pair of fitting portions.

The flow path connection module may include a first space through which water supplied to the wash water nozzle passes; and a second space partitioned from the first space through which water sucked into the wastewater inlet passes, and the second space may be larger than the first space.

The first space may be arranged above the second space.

The robot cleaner station may further include an accommodating space disposed within the housing, and configured to accommodate at least a portion of the robot cleaner is accommodated; and an air discharge unit configured to discharge air from the accommodating space, and the air discharge unit may include an air suction hole in communication with the accommodating space; and an air discharge pipe configured to discharge air sucked in from the air suction hole. The air discharge pipe branches out to the left and right sides and is coupled to each of the pair of fitting portions.

In another aspect, a robot cleaner station according to an embodiment of the present disclosure may include a housing; a washing plate disposed below a mop of a robot vacuum cleaner and used to clean the mop; a water supply connection pipe disposed within the housing and configured to supply fluid from an external water source to the washing plate; a drain connection pipe disposed within the housing and used to discharge fluid passing through the cleaning plate; and a flow connection module connected to the water supply connection pipe and the drain connection pipe. The water supply connection pipe and the drain connection pipe may be pivotally connected to the flow path connection module.

### Advantageous Effect

As described above, the robot cleaner station according to the present disclosure, with the modules for charging the robot cleaner, collecting dust, and washing the mop, is arranged horizontally with the robot cleaner, effectively utilizing the space underneath the kitchen cabinet.

Furthermore, the charging terminal, dust collection unit, mop washing unit, and mop drying unit are arranged in a manner surrounding the robot cleaner, thereby enabling the robot cleaner to perform various functions simultaneously.

Still further, the wash water supply unit, washing plate, washing tank, wastewater discharge path, external air supply module, and power supply module are centrally located at the rear of the robot cleaner's mop, thereby enabling both mop washing and drying within a limited space.

Still further, since all surfaces except the front are covered by kitchen cabinets, the robot cleaner provides an aesthetically pleasing interior design.

Still further, when the robot cleaner is coupled, the robot cleaner automatically collects dust within its dust bin, so the user only needs to remove the dust bin periodically, reducing the user's workload.

Still further, when the robot cleaner is coupled, the robot cleaner's mop may be automatically cleaned, reducing the hassle of having to remove and wash the mop separately.

Still further, detergent may be added as needed, enhancing the mop's cleaning efficiency.

Still further, since the mop is washed using the kitchen water supply and drain pipes, it reduces the user's inconvenience of having to separately add water or drain wastewater.

Still further, after washing the mop of the robot cleaner, hot air is supplied to the mop to automatically dry it and then discharged, preventing the generation of unpleasant odors.

Still further, during the mop drying process, the dried air is discharged downstream of the oil trap, preventing the backflow of unpleasant odors.

Still further, when the robot cleaner enters the robot cleaner station, the door of the robot cleaner station closes, preventing dust from flying outside while the dust bin is being collected.

Still further, when washing the mop of the robot cleaner, the wastewater is prevented from leaking outside.

Still further, when washing the mop of the robot cleaner, the connection location of the water supply pipe and drain pipe may be selectively set to the left or right of the station, thereby having the effect of maximizing the installation efficiency of the robot cleaner station.

### DESCRIPTION OF DRAWINGS

FIG. 1 is a view to describe a cleaner system according to embodiments that is installed in a lower portion of a kitchen furniture;

FIG. 2 is a view to describe the relationship in which a pipe of the cleaner system according to embodiments of the present disclosure is connected to a drain pipe;

FIG. 3 is a perspective view to describe a cleaner system according to embodiments of the present disclosure;

FIG. 4 is a plane view of FIG. 3;

FIG. 5 is a cross-sectional view of FIG. 3 cut along a front-back direction;

FIG. 6 is a perspective view to describe a robot cleaner according to embodiments of the present disclosure;

FIG. 7 is a side view of FIG. 6;

FIG. 8 is a bottom view of FIG. 6;

FIG. 9 is a rear view of FIG. 6;

FIG. 10 is a perspective view to describe a robot cleaner station according to embodiments of the present disclosure;

FIG. 11 is a plane view of FIG. 10;

FIGS. 12 and 13 are side views to describe a dust collection path of the robot cleaner station according to embodiments of the present disclosure;

FIG. 14 is a cross-sectional view to describe a dust collection path of a robot cleaner station according to embodiments of the present disclosure;

FIG. 15 is an enlarged view showing a mop washing unit of a robot cleaner station according to an embodiment of the present disclosure;

FIG. 16 is an enlarged view illustrating a wash water supply unit of a mop washing unit of a robot cleaner station according to an embodiment of the present invention.

FIG. 17 is a view showing a state in which a dust collection unit and a detergent container are withdrawn from a robot cleaner station according to an embodiment of the present disclosure;

FIG. 18 is a perspective view showing a mop drying unit of a robot cleaner station according to an embodiment of the present disclosure;

FIG. 19 is an enlarged view of a mop drying unit of the robot cleaner station according to an embodiment of the present disclosure;

FIG. 20 is a cross-sectional view to describe air that flows into an external air supply module according to an embodiment of the present disclosure;

FIGS. 21 and 22 are views to describe the arrangement relationship on a horizontal side of the robot cleaner station according to embodiments of the present disclosure;

FIG. 23 is a view showing a state in which a drawer is provided in a robot cleaner station according to an embodiment of the present invention;

FIG. 24 is a view showing a state in which a drawer is withdrawn in a robot cleaner station according to an embodiment of the present disclosure;

FIG. 25 is a block view showing a control configuration in a robot cleaner station according to an embodiment of the present disclosure;

FIG. 26 is a view showing a state in which a water supply connection pipe and a drain connection pipe are connected to a fitting portion disclosed on the right outer wall in a robot cleaner station according to an embodiment of the present disclosure;

FIG. 27 is a view showing a state in which a water supply connection pipe and a drain connection pipe are connected to a fitting positioned on the left outer wall in a robot cleaner station according to an embodiment of the present disclosure;

FIG. 28 is a view showing a flow path connection module in a robot cleaner station according to an embodiment of the present disclosure and

FIG. 29 is a cross-sectional view showing the internal space of a flow path connection module in a robot cleaner station according to an embodiment of the present disclosure.

### DESCRIPTION OF SPECIFIC EMBODIMENTS

Description will now be given in detail according to exemplary embodiments disclosed herein, with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

Terms of respective elements used in the following description are terms defined taking into consideration of the functions obtained in the present invention. Therefore, these terms do not limit technical elements in the present invention. Further, the defined terms of the respective elements will be called other terms in the art. It will be understood that although the terms first, second, etc. may be used herein to describe various elements, these elements should not be limited by these terms. These terms are generally only used to distinguish one element from another.

The term “and/or” may include any combination of multiple related listed items or any one of multiple related listed items.

It will be understood that when an element is referred to as being “connected with”, “on” or “coupled to” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. In understanding the components, it should be understood as including the error range even if there is no separate explicit description.

Throughout the disclosure, each component can be provided as a single one or a plurality of ones, unless explicitly stated to the contrary. Terms such as “comprise”, “include” or “has” are used herein and should be understood that they are intended to indicate an existence of several components, functions or steps, disclosed in the specification, and it is also understood that greater or fewer components, functions, or steps may likewise be utilized.

Terminology that is used in the present disclosure is limited to only for embodiments herewith but made only to make it easy to understand the present disclosure. Terms of respective elements used in the following description are terms defined taking into consideration of the functions obtained in the present invention. Therefore, these terms do not limit technical elements in the present invention. Further, the defined terms of the respective elements will be called other terms in the art.

Hereinafter, referring to the accompanying drawings, embodiments of the present disclosure will be described in detail, to be understood by those skilled in the art to which the present disclosure pertains. The shape and size of elements in the drawings may be exaggerated for clearer explanation.

### Kitchen cabinet and Cleaner system:

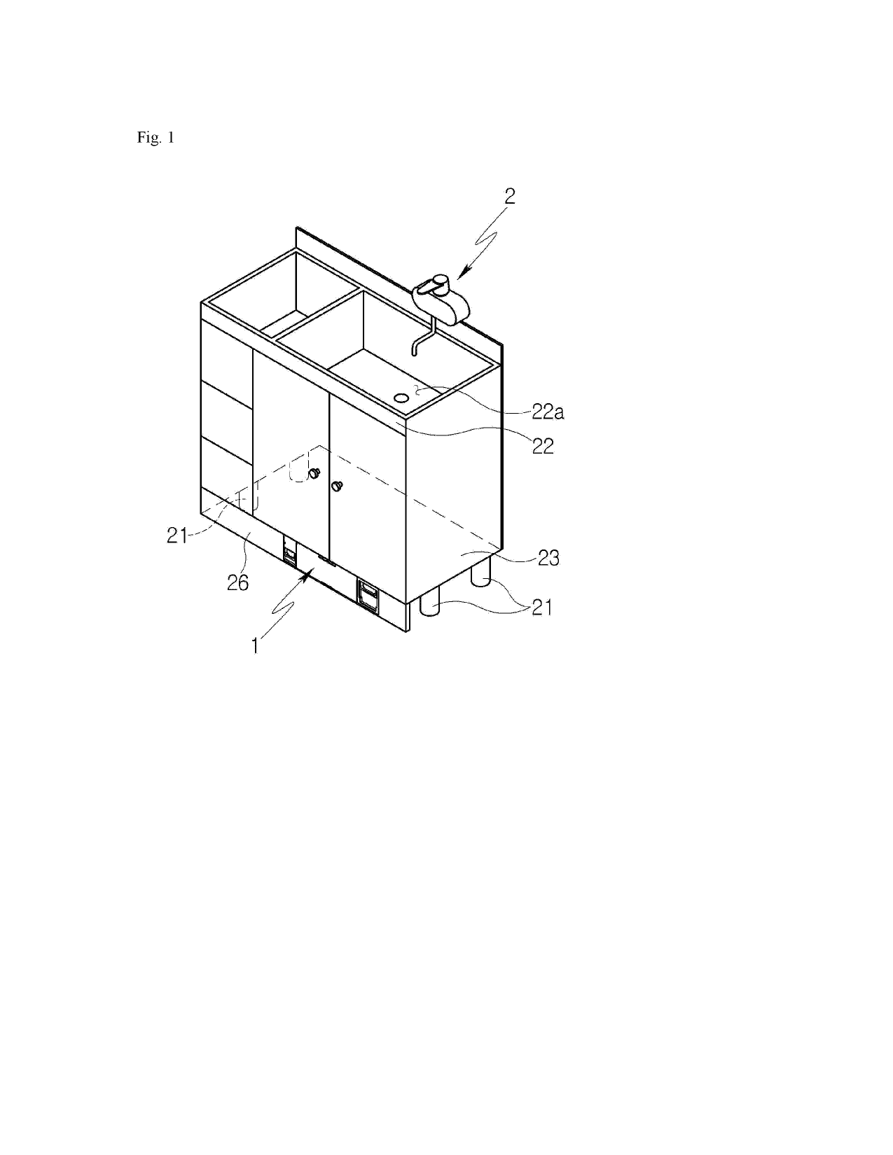

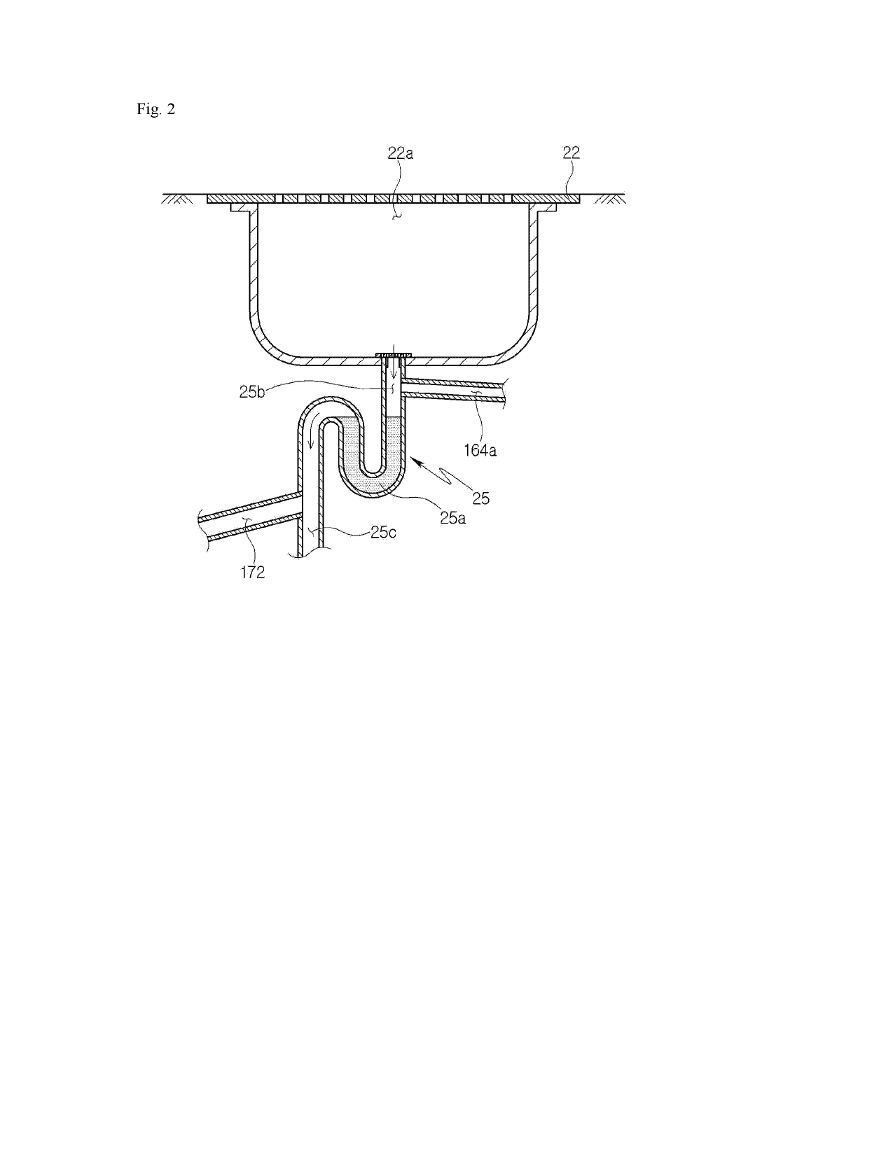

FIG. 1 is a view to describe a cleaner system according to embodiments that is installed in a lower portion of a kitchen cabinet. FIG. 2 is a view to describe the relationship in which a pipe of the cleaner system according to embodiments of the present disclosure is connected to a drain pipe.

The cleaner system 1 according to embodiments of the present disclosure may be provided in a lower portion of a kitchen cabinet 2. Specifically, the kitchen cabinet 2 is placed in the kitchen and may store dishes, plates, cups, etc., and may provide a space for cooking food or washing dishes.

In addition, the kitchen cabinet 2 may be provided with a worktop that may serve as a sink, cooling surface, or work surface.

For example, the kitchen cabinet 2 may include a sink that provides a space for washing dishes on a top surface. Or, the kitchen cabinet may have a kitchen countertop on which cooking tasks are performed. In addition, the kitchen cabinet 2 may include a gas range surface with a gas range, induction range, highlighter or oven installed on the top surface.

Generally, the kitchen cabinet 2 may be made of a standard cabinet with a width of 600 mm in the front-back direction and a width of 600 mm in the left-right direction.

A cleaner system 1 according to another embodiment may be provided in a lower portion of a structure including at least one of water supply pipe or a drain pipe. Specifically, the water supply pipe may mean a path connected with an external water supply source for supplying fluids to the structure, and the pipe may mean a path for draining the fluid discharged from the structure into a sewer.

A storage cabinet for storing dishes and kitchen tools, etc. may be provided in a lower portion of the above-mentioned kitchen cabinet 2 or structure. That is, the kitchen cabinet 2 or the structure may include an upper plate 22 that provides a space for cooking, dishwashing or other tasks, a lower plate 23 spaced apart at a predetermined height from the floor, and a storage space formed between the upper plate 22 and the lower plate 23 to store dishes and kitchen tool. In this case, if the kitchen cabinet 2 is a kitchen sink, a sink 22a may be provided on the upper plate 22.

The lower plate 23 may be supported by a pedestal 21. The pedestal 21 may arranged along a direction perpendicular to the floor of the kitchen and may support the load of the kitchen cabinet 2. At this time, a space may be formed between the floor of the kitchen and the lower plate 23 based on the height of the pedestal 21.

Alternatively, it is also possible to fix the kitchen cabinet 2 to the wall of the building without the pedestal 21. In this case, a space may be formed between the kitchen floor and the lower plate 23.

The cleaner system 1 according to the embodiments may be mounted in the space formed between the floor of the kitchen and the lower plate 23 as mentioned above (hereinafter, referred to as “the mounting space”).

For example, the mounting space may have a height of 200mm or less and generally a height of 160mm or less.

According to the present disclosure, since the cleaner system 1 is disposed in the lower space of the kitchen cabinet 2, there is an effect of minimizing the exposure of the cleaner 1 to the outside.

In addition, compared to placing a charging stand for a robot cleaner in a certain space in a living room, a room, or a kitchen, the cleaner system 1 is placed in an unused space created by the kitchen cabinet 2 without taking up a separate space, accordingly, there is an effect of maximizing space efficiency.

Meanwhile, a drain pipe 25 for draining the liquid used in cooking or water used in dishwashing may be provided in the kitchen cabinet 2 or the structure. At least predetermined portion of the drain pipe 25 may be disposed in the storage space formed between the upper plate 22 and the lower plate 23. Generally, the drain pipe 25 may be connected a drain hole formed in the sink 22a. The drain pipe 25 may include a U-trap 25a to prevent the backflow of contaminated gas or foul odor. The U-trap 25a may be placed in the storage space. Liquid introduced through the drain hole may flow down due to gravity in upstream 25b of the U-trap, accumulates in the U-trap 25a, and when the water level rises above a predetermined level set by the U-trap 25a, it flows down along the downstream 25c of the U-trap and may be discharged through the sewer.

The cleaner system 1 according to embodiments of the present disclosure may wash and dry the mop 242 of the robot cleaner 200 by using the above-mentioned drain pipe 25.

Although not shown, a water supply pipe may be provided in the kitchen cabinet 2. Constant water (or purified water) may be supplied to the cleaner system 1 through the water supply pipe.

Hereinafter, the specific structure of the cleaner system 1 will be described.

### Cleaner system:

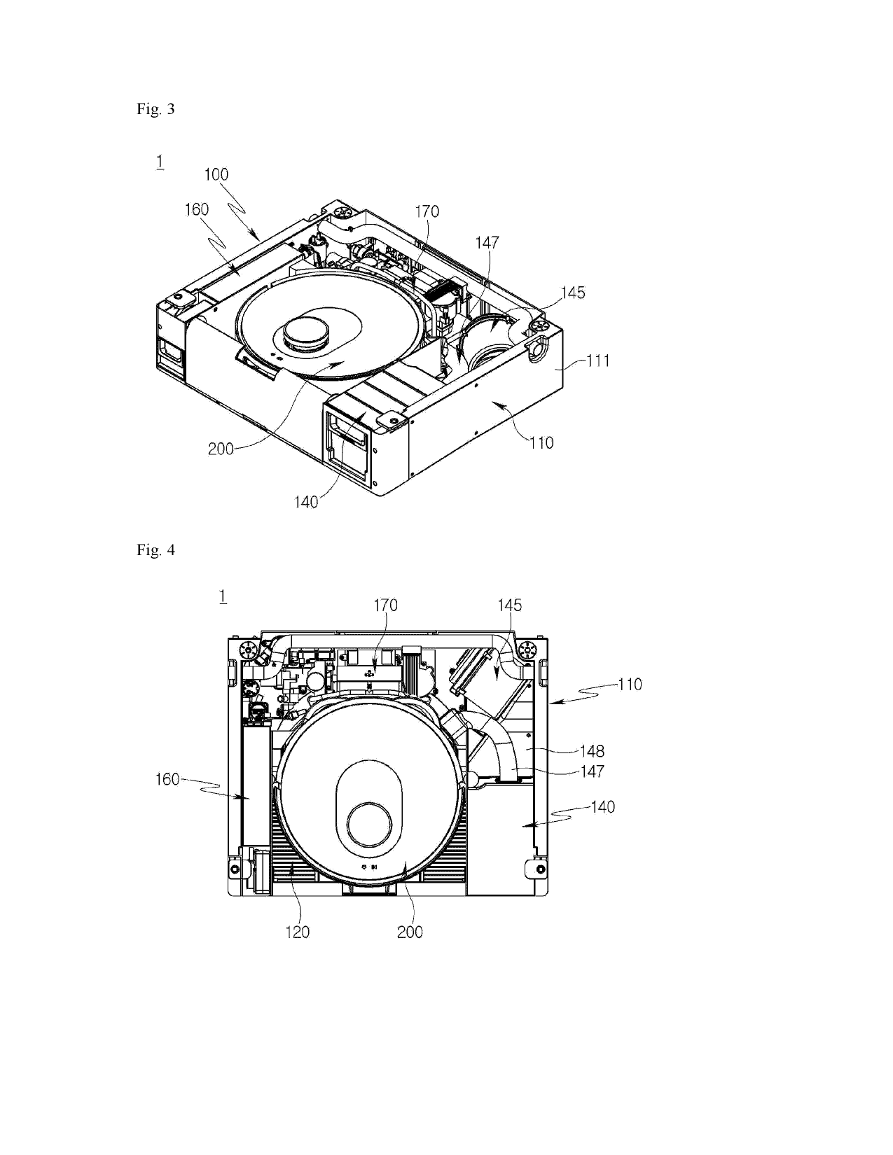

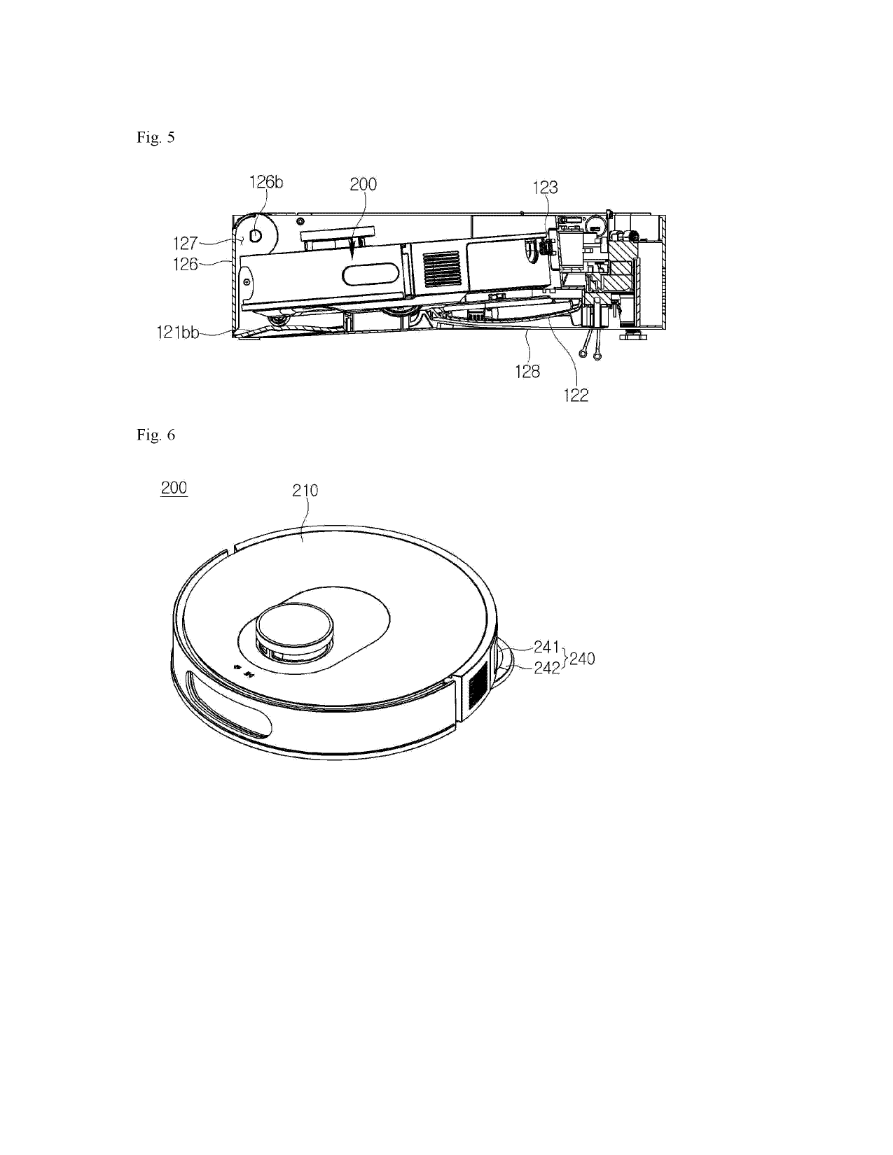

Meanwhile, FIGS. 3 through 5 are views to describe the cleaner system according to embodiments of the present disclosure.

The cleaner system 1 according to embodiments of the present disclosure may include a robot cleaner station 100 and a robot cleaner 200.

The cleaner system 1 may include the cleaner station 100. The robot cleaner 200 may be mounted to the robot cleaner station 100. Specifically, the robot cleaner 200 may enter into a front side of the robot cleaner station 100, and may be accommodated within the robot cleaner station 100. The robot cleaner station 100 may remove dust of a dust bin 220 of the robot cleaner 200. The robot cleaner station 100 may wash the rotary cleaning unit 240 of the robot cleaner 200. The robot cleaner station 200 may dry a rotary cleaning unit 240 of the robot cleaner 200. The robot cleaner station 200 may supply power to the robot cleaner.

### Robot cleaner:

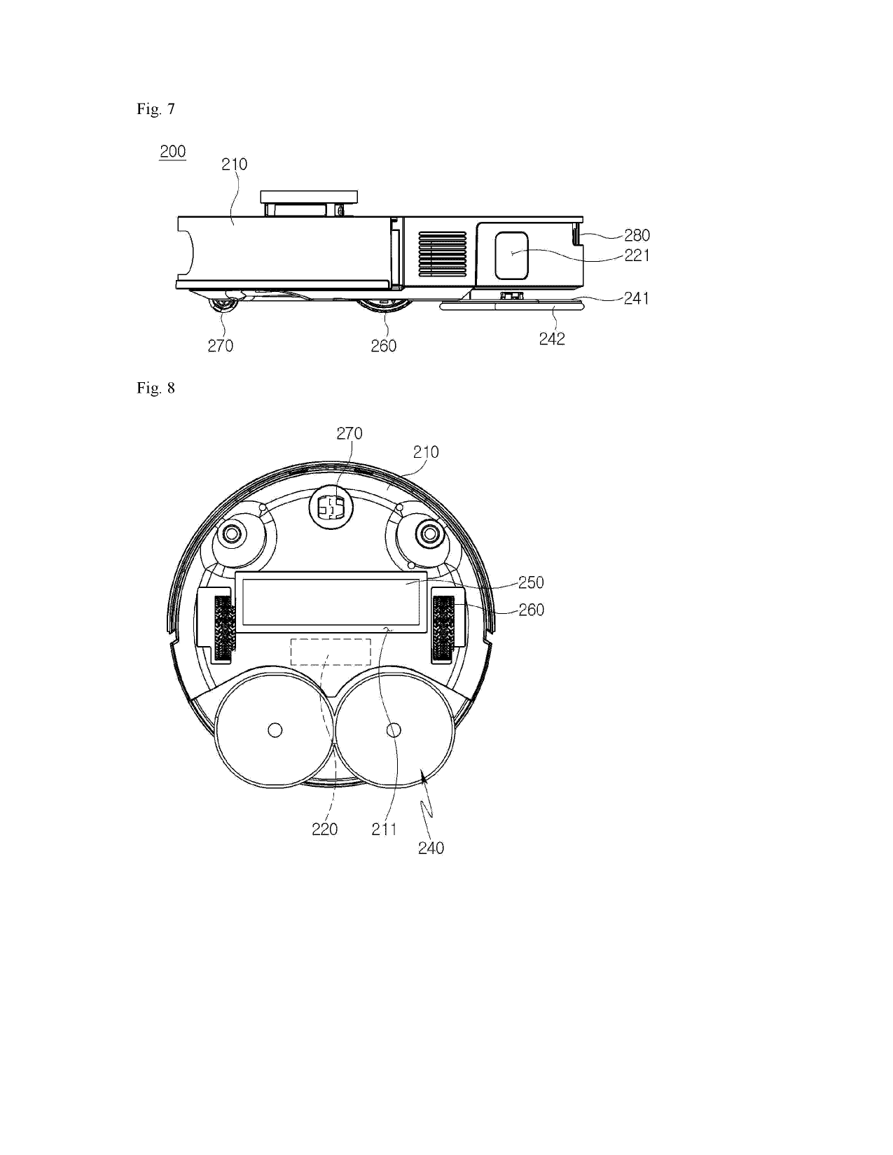

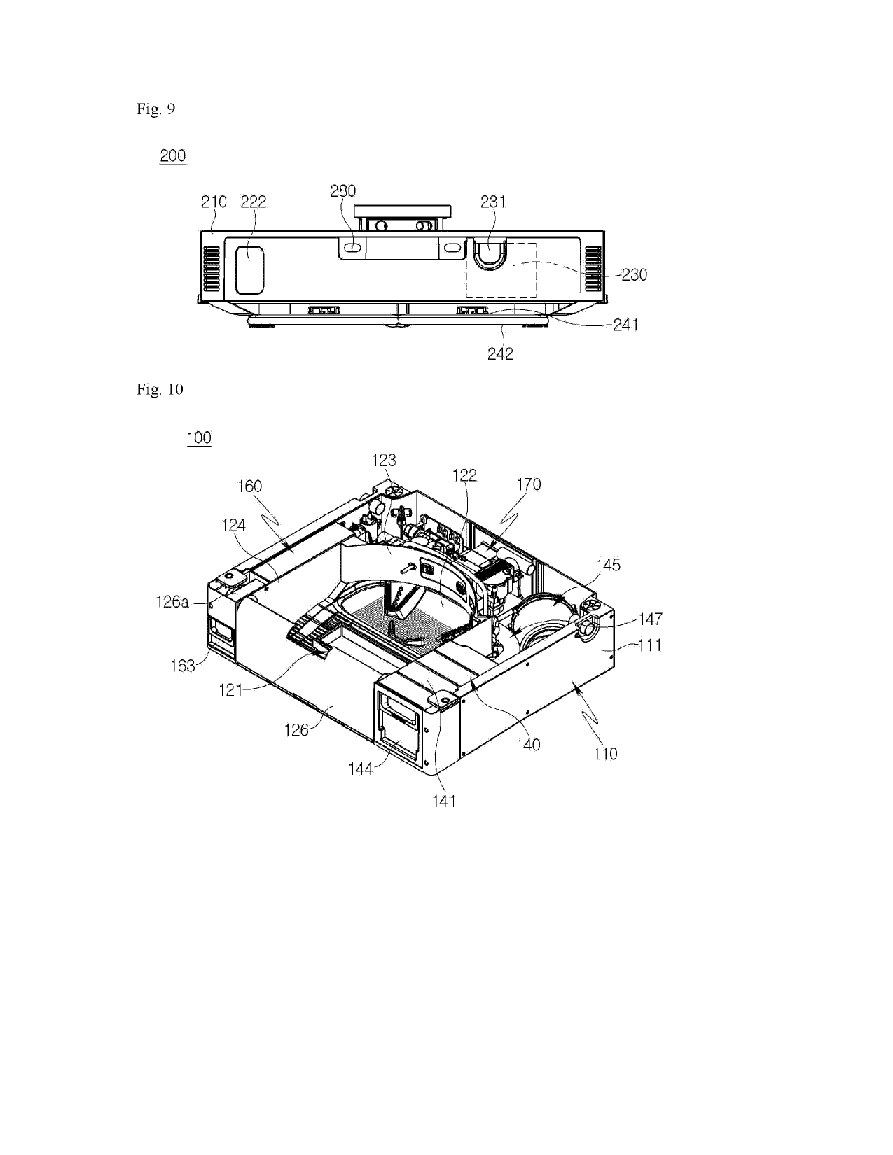

Meanwhile, FIGS. 6 to 9 are views to describe the robot cleaner in the cleaner system according to embodiments of the present disclosure.

Referring to FIGS. 6 to 9, the structure of the robot cleaner 200 will be described as follows.

The robot cleaner 200 may automatically clean an area to be cleaned by moving around the area to be cleaned and sucking up foreign substances such as dust from the floor.

The robot cleaner 200 according to embodiments may be configured to clean the floor while placed on the floor and moving along the floor. Accordingly, the following description will be made by determining the up-down direction based on the state where the robot cleaner 200 is placed on the floor.

Based on a pair of wheels 260, the side where an auxiliary wheel 270 to be described later is placed may be set as the front, and the side where a rotary cleaning unit 240 to be described later is placed may be set as the rear.

The “lowermost portion” of each element described in embodiments of the present disclosure may be the portion positioned lowest in each element when the robot cleaner 200 according to embodiments of the present disclosure is used while placed on the floor, or may be the portion closest to the floor.

The robot cleaner 200 according to embodiments of the present disclosure may include a body 210, a dust bin 220, a water tank 230, a rotary cleaning unit 240, an agitator 250, a wheel 260, an auxiliary wheel 270, and a charging terminal 280.

The body 210 may defined the overall exterior of the robot cleaner 200. Each component of the robot cleaner 200 may be coupled to the body 210, and some components of the robot cleaner 200 may be accommodated inside the body 210.

Specifically, components of the robot cleaner 200 may be provided in a space formed inside the body 210. As one example, the space inside the body 210 may accommodate a battery and at least one motor.

In embodiments of the present disclosure, the body 210 may be formed in a shape in which the width (or diameter) in the horizontal direction (parallel to X and Y) is greater than the height in the vertical direction (parallel to Z). This body 210 may help the robot cleaner 200 to have a stable structure, and provide a structure that is advantageous in avoiding obstacles when the robot cleaner 200 moves (or drives).

When viewed from above or below, the body 210 may be formed in various shapes such as circular, oval, or square.

The body 210 may be divided into an upper body and a lower body. The lower body and the upper body are coupled to each other to define an inner space.

The lower body may be coupled to the upper body to form the space in which a battery, at least one sensor, and at least one motor may be accommodated.

The lower body may be formed with a suction port 211 configured to introduce air and a hole for accommodating a pair of wheels 260.

The suction port 211 may be a path through which dust introduces dust of the floor, and the suction port 211 may be in communication with a suction path (not shown) formed inside the body 210. The suction path may be in communication with an inner space of the dust bin 220.

Meanwhile, an air discharge path may be further provided in the lower body. The air discharge path has one side connected to the inner space of the dust bin 220 and the other side connected with an outlet hole. At this time, a filter may be disposed at the outlet hole.

With this configuration, the air introduced through the suction port 211 may flow into the dust bin 220 through the suction path, and may be discharged to the air discharge hole through the air discharge path.

The agitator 250 to be described later may be rotatably mounted in the suction port 211. With this configuration, dust around the suction port 211 may be guided into the suction port 211 by the rotation of the agitator 250, and the efficiency of sucking dust can be increased.

The upper body may be configured to define the upper exterior of the robot cleaner 200. Although not shown, a display may be provided on the upper body.

The robot cleaner 200 according to the present disclosure may include a bumper. The bumper may be coupled along the edge of the body 210, but may be configured to move relative to the body 210.

The bumper may be coupled along some area of the edge of the body 210, or along the all area of the edge of the body 210. At least one elastic member (not shown) may be provided between the bumper and the body 210. With this configuration, when comes into contact with an obstacle or the like and moves relative to the center of the body 210, the bumper can return to its original position by the restoring force of the elastic member (not shown), and may absorb or disperse the shock applied to the bumper, thereby preventing and reducing the shock from being transmitted to the body 210.

The dust bin 220 may be provided to suck dust and air from the outside and store the dust.

The dust bin 220 may be configured to store dust flowing through the suction path. The dust bin 220 may have a dust inlet hole that is in communication with the suction path, an inner space for storing dust, and an air outlet hole through which air is discharged.

The dust bin 220 may be provided within the body 210. At this time, the dust bin 220 may be secured to the body 210 or it may be detachably coupled to the body 210 according to an embodiment.

Meanwhile, a dust outlet path may be formed in the dust bin 220 according to the present disclosure. The dust outlet path may make the inner space of the dust bin 220 communicate with the external space of the robot cleaner 200. With this configuration, when dust collects by using the robot cleaner station 100, dust stored inside the dust bin 220 may b removed.

Meanwhile, the dust bin 220 according to embodiments may have a dust outlet hole 221 in communication with the dust outlet path. As one example, the dust outlet hole 221 may be formed on a rear side of the outer surface (or outer circumferential surface) of the body 210. As another example, the dust outlet hole 221 may be formed on an outer surface of the dust bin 220.

A dust bin door 222 configured to selectively open and close the dust outlet hole 221 may be provided in the robot cleaner 200 according to embodiments of the present disclosure. Specifically, the dust bin door 22 may be coupled to the body 210 and disposed at a position that may block the dust outlet hole 221. For example, the dust bin door 222 may be made of rubber or resin material and flappably provided so that one side can be fixedly connected to the body 210.

With this configuration, when a dust collecting motor 152 provided in the robot cleaner station 100 to be described later is operated, the dust bin door 222 may be elastically deformed by the driving force of the dust collecting motor 152, and the dust outlet hole 221 is opened, so that dust inside the dust bin 220 can be collected by the dust collection unit 140 of the robot cleaner station 100.

The water tank 230 may be formed in a shape of a container having an inner space to store a liquid such as water. The water tank 230 may be disposed inside the body 210, and fixedly coupled to the body 210 or detachably coupled to the body 210.

The water tank 230 may include a supply portion 231 and a nozzle (not shown). The supply portion 231 may be configured to supply a liquid such as water to the water tank from the outside. For example, the supply portion 231 may have a water injection hole formed on a rear side of the outer surface (or outer circumferential surface) of the body 210 and may be connected to the storage space formed inside the water tank 230 through a water supply hose.

At this time, the supply potion 231 may be placed on the opposite left and right sides of the robot cleaner 200 in relation to the dust discharge hole 221. For example, when the dust discharge hole 221 is disposed on the rear left side of the body 210, the supply portion 321 may be disposed on the rear right side of the body 210.

With this configuration, in a state where the robot cleaner 200 is coupled to the robot cleaner station 100, the robot station 100 may simultaneously perform dust collection and water injection.

Meanwhile, the nozzle (not shown) may be formed in a tube or pipe shape, and may be connected to the water tank 230 so that the liquid inside the water tank 230 can flow there through. The nozzle (not shown) may have one end connected to the water tank 230 and the other end positioned above a pair of rotary plates 241, so that the liquid inside the water tank 230 can be supplied to the pair of mops 242.

That is, the nozzle (not shown) may have a shape of a single pipe branching into two. At this time, one end of the branched pipe may be positioned above the left rotary plate and the other end thereof may be positioned above the right rotary plate.

Meanwhile, although not shown, a pump may be provided in the water tank 230 and may be configured to flow the water inside the water tank to the nozzle (not shown). Accordingly, when the pump of the water tank 230 is operated, the liquid stored inside the water tank 230 may be discharged to the rotary cleaning unit 240 through the nozzle (not shown).

The rotary cleaning unit 230 may include the rotary plate 241 and the mop 242.

The rotary plate 241 may include a pair of left and right rotary plates, and the mop 242 may include a pair of left and right mops.

The rotary plate 241 may be rotatably provided on a lower surface of the body 210, and the mop 241 may be coupled to a lower surface of the rotary plate 241.

The rotary plate 241 may have a predetermined area, and may be formed in a shape of a flat plate or frame. The above-mentioned rotary plate 241 may be generally laid horizontally, and may be formed in a shape in which the horizontal width (or diameter) is sufficiently larger than the vertical height. The rotary plate 241 coupled to the body 210 may be parallel to the floor surface, or may be inclined with the floor surface, or may be inclined with respect to the floor surface. The rotary plate 241 may be formed in a circular plate shape, the lower surface of the rotary plate 241 may be generally circular and the rotary plate 241 may form an overall rotational symmetry.

The pair of rotary plates 241 may be symmetrical to each other.

The mop 242 may be coupled to the lower surface of the rotary plate to face the floor surface.

The mop 242 may be formed so that the bottom surface facing the floor can have a predetermined area, and the mop 242 may be formed in a flat shape. The mop 242 may be formed in a shape in which the horizontal width (or diameter) is sufficiently larger than the vertical height. When the mop 242 is coupled to the body 210, the lower surface of the mop 242 may be parallel to the floor surface or may be inclined with respect to the floor surface.

The lower surface of the mop 242 may be generally circular, and the mop 242 may be formed in an overall rotationally symmetrical shape. In addition, the mop 242 may be detachably coupled to the lower surface of the rotary plate 241, and coupled to the rotary plate 241 to rotate together with the rotary plate 241.

Although not shown, a driving unit configured to apply a rotational force to the rotary plate 241 may be provided in the rotary cleaning unit 240. For example, the driving unit may include a motor and at least one gear. Accordingly, when the driving unit is operated, the rotary plate 241 and the mop 242 may rotate together to mop and clean the floor surface.

The agitator 250 may include a plurality of rotatable brushes configured to guide dust and air into the dust bin 220 from the outside. At this time, the agitator 250 may include at least one gear.

Meanwhile, the agitator 250 according to this embodiment may be configured to receive rotational power from a separate agitator motor (not shown) and also receive rotation power from the driving motor according to embodiments, or may be configured to receive rotational power from the driving unit of the rotary cleaning unit 240.

The wheel 260 may be provided on the lower surface of the body 210 and connected to the driving unit (not shown). At this time, the driving unit (not shown) may be coupled to the body 210.

The wheel 260 may be provided in the body 210 and configured to roll on the floor surface.

The wheel 260 may be configured of a first driving wheel and a second driving wheel. At this time, the first driving wheel may be the same as the second driving wheel, or they may be formed symmetrically. As one example, when the first driving wheel is arranged on the left side of the robot cleaner 200, the second driving wheel may be arranged on the right side of the robot cleaner 200, and in this case, the first driving wheel and the second driving wheel may be symmetrical to each other.

The driving unit (not shown) may include a driving motor and a gear. Here, the driving motor may be mounted inside the body 210 and configured to provide power to the wheel 260. The driving motor may include a first driving motor and a second driving motor.

The driving motor may be configured of an electric motor. A plurality of gears may be formed engage with each other and rotate, connect the driving motor and the wheel 260 with each other, and transmit the rotational power of the driving motor to the wheel 260. Accordingly, the wheel 260 may rotate when the rotation axis of the driving motor rotates.

With this configuration, when the driving motor is operated, the wheel 260 may rotate and the body 210 may move at a predetermined driving speed on the floor surface.

An auxiliary wheel 270 may be provided on the lower surface of the body 210 and configured to roll on the floor surface (the cleaning target). The auxiliary wheel 270 may support the body 210 on the floor surface together with the pair of wheels 260. With this configuration, the auxiliary wheel 270 may be configured to guide the movement of the robot cleaner 200 while minimizing friction between the robot cleaner 200 and the floor.

The suction motor (not shown) may be configured to generate a suction power for sucking dust and air from the outside through the suction port 211. For example, the suction motor (not shown) may be an electric motor. External dust and air may be introduced into the suction port 211 by the suction force generated from the suction motor (not shown) and may reach the dust bin 220 after pashing through the suction path.

Although not shown, a battery may be coupled to the body 210 and configured to supply power to the other components composing the robot cleaner 200. The battery may be configured to supply power to at least one motor provided in the robot cleaner 200. For example, the battery may provide power to the rotary cleaning unit 240, the agitator 250, the wheel 260, and the motor provided in the suction motor (not shown).

In addition, the battery may be configured to supply power to the sensor unit (not shown) and the control unit (not shown).

The battery may be charged by an external power source, and for this purpose, a charging terminal 280 may be provided on one side of the body 210. For example, the charging terminal 280 may receive power by coming into contact with a power supply terminal 123b of the robot cleaner station 100 when the robot cleaner 200 is mounted to the robot cleaner station 100.

### Robot cleaner station:

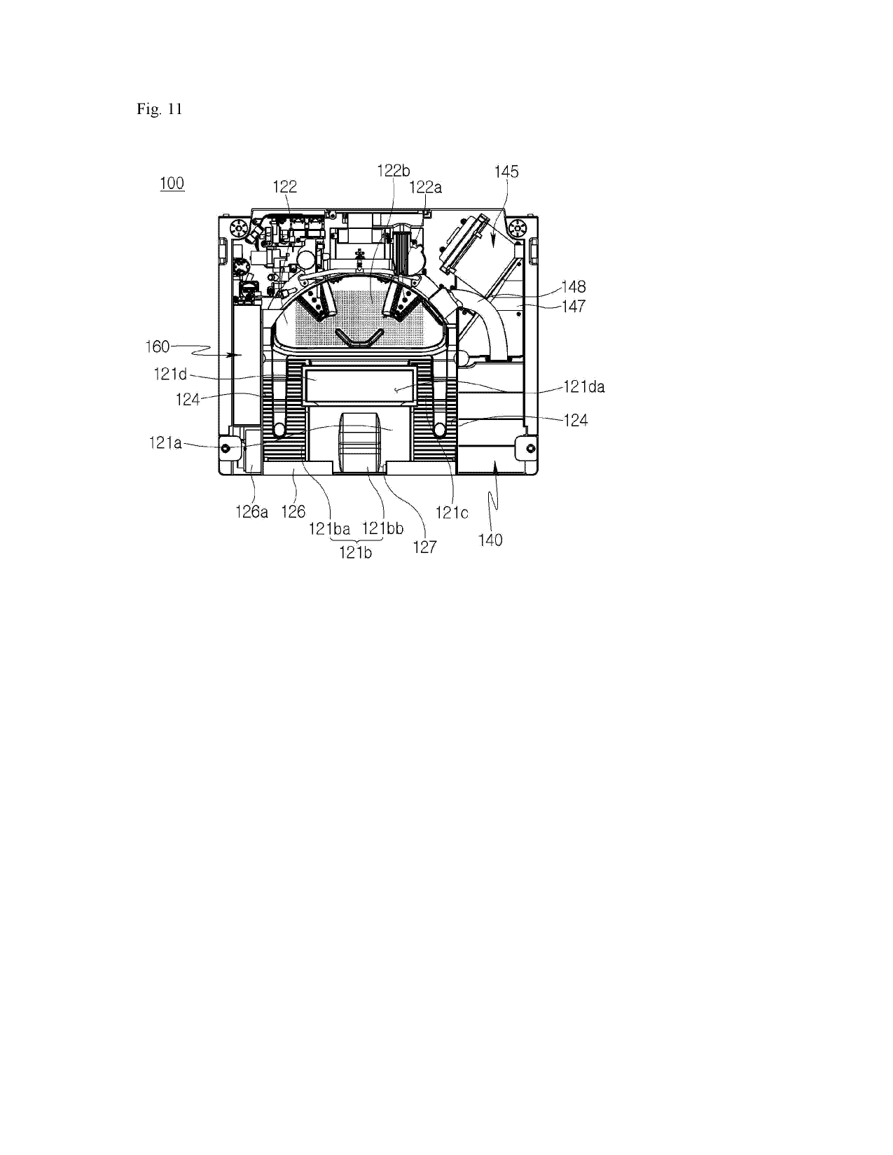

FIG. 10 is a perspective view to describe a robot cleaner station according to embodiments of the present disclosure. FIG. 11 is a plane view of FIG. 10.

Referring to FIGS. 10 and 11, the robot cleaner station 100 according to the present disclosure will be described as follows.

The robot cleaner 200 may be mounted in the robot cleaner station 100. The robot cleaner 200 may be mounted to a mounting unit 120 of the robot cleaner station 100.

The robot cleaner station 100 may include a housing 110.

The housing 110 may define the exterior of the robot cleaner station 100. For example, the housing 110 may be formed in a shape similar to a hexahedron having at least one outer wall surfaces.

The housing 110 may have a space formed to accommodate the mounting unit 120, a dust collection path 130, a dust collection unit 140, a dust collection motor 145, a mop washing unit 160, a mop drying unit 170, and the air discharge path 125a.

The housing 110 may be mounted in a lower portion of the kitchen cabinet 2. Specifically, the housing 110 may be installed in a mounting space 24 formed between the lower plate 23 of the kitchen cabinet 2 and the floor of the kitchen.

The housing 110 may include a pair of outer wall surfaces 111 facing each other. The outer wall surfaces 111 may mean surfaces formed along the gravity direction.

As one example, the pair of outer wall surfaces 111 may be installed in the lower portion of the kitchen cabinet 2 at a predetermined distance from the floor. As another example, the housing 110 may further include a bottom surface 112 facing the floor of the kitchen, and the pair of outer wall surfaces 111 may be connected to each other through the bottom surface 112. As a further example, the housing 110 may further include a bottom surface 112 facing the floor of the kitchen and an upper surface 112 facing the lower surface 23 of the kitchen cabinet 2. The upper and lower ends of the pair of outer wall surfaces 111 may be connected to each other through the bottom surface 112 and the upper surface. As a further example, the housing 110 may further include a rear surface facing the bottom surface 112, the upper surface, and the wall of the building.

As another example, the housing 110 further includes a bottom surface facing the floor of the kitchen and an upper surface 113 facing the lower plate 23 of the kitchen cabinet 2, and the upper and lower ends of a pair of outer walls 111 may be connected to each other through the bottom surface and the upper surface 113. Therefore, even if a foreign substance falls downward from the kitchen cabinet 2. the components of the robot cleaner 200 and the robot cleaner station 100 may be prevented from being contaminated. As another example, the housing 110 may further include the bottom surface, the upper surface 112, and a rear surface 111b facing the wall of the building.

With this configuration, the components of the robot cleaner station 100 may be accommodated inside the housing 110 (between the pair of outer wall surfaces 111).

In addition, the robot cleaner 200 may be mounted inside the housing 110. The housing 110 may be arranged so that the pair of outer wall surfaces 111 have a gap (or distance) greater than the maximum horizontal width of the robot cleaner 200. With this configuration, the robot cleaner 200 may enter and exit the housing 110.

At this time, the robot cleaner 200 according to this embodiment may enter or exit from the front of the robot cleaner station 100. Here, the front may mean the direction in which the door 126 is provided with respect to the inside of the robot cleaner station 100.

The rear means the opposite direction of the front with respect to the inside of the robot cleaner station 100. For example, the building wall (not shown) may be placed at the rear of the robot cleaner station 100.

When looking forward from the inside of the robot cleaner station 100, the left side may be called the left direction and the right side may be called the right direction.

That is, the outer wall surfaces of the robot cleaner station 100 may be disposed in the left direction and the right direction, respectively.

Accordingly, the top of the housing 110 may be covered by the kitchen cabinet 2, and the bottom of the housing 110 may be covered by the kitchen floor. In addition, the left and right surfaces of the housing 110 may be covered by the outer walls 111, but may be placed in the lower portion of the kitchen cabinet 2. At this time, the lower portion of the kitchen cabinet 1 may be finished by a baseboard except the robot cleaner station 100, thereby exposing only the front surface of the housing 110 to the outside.

Through this, it is possible to minimize the exposure of the robot cleaner station 100 and the robot cleaner 200 to the outside.

With this configuration, the robot cleaner 100 according to the present disclosure has an effect of providing an aesthetic appeal to the user in terms of interior design.

Meanwhile, although not shown, in the housing 110 may be formed a space through which a water supply hose connected to the water supply pipe passes, a space through which a drain hose for discharging waste water generated after the mop 242 is washed passes, and a space a hose for discharging moisture generated during a drying process for the mop 242 passes. For example, the space through which the hoses can pass may be formed on at least one of the outer wall surfaces 111, and the upper surface 112.

### Mounting unit:

As shown in FIG.11, the robot cleaner station 100 may include the mounting unit 120.

The robot cleaner 200 and the robot cleaner station 100 may be physically, electrically and/or wiredly connected with each other through the mounting unit 120.

The mounting unit 120 may be disposed inside the housing 110.

At this time, the mounting unit 120 may be retractable (or withdrawable) from the housing 110 through a drawer 190.

With this configuration, when the mounting unit 120 needs leaning or repairing, or when some components need replacing, there is an effect in which the user can easily withdraw and manage the mounting unit 120.

An introduction opening 127 through which the robot cleaner 200 is introduced may be formed in the mounting unit 120. The entrance 127 may mean a space formed on the front surface of the robot station 100.

The entrance 127 may have a size that is large enough for the robot cleaner 200 to pass through. That is, the heigh of the entrance 127 may be greater than that of the robot cleaner 200. At this time, the entrance 127 may mean a space formed upward along a vertical direction from the front end of the base 121, which will be described later. The upper end of the entrance may be the same as the lower surface of the lower plate 23 of the kitchen cabinet 2 or the upper end of the housing 110.

In addition, the left-right width of the entrance 127 may be greater than the maximum width of the robot cleaner 200. At this time, at least one of the dust collection unit 140 and the mop washing unit 160 may be disposed on left and right sides of the entrance 127. Accordingly, the left and right ends of the entrance 127 may form a boundary with the dust collection unit 140 and the mop washing unit 160. If there is no dust collection unit 150 or mop washing unit 160, the outer wall surface 111 of the housing may form the boundary.

At this time, the entrance 127 may be closable by the door 126. The door 126 may be provided at the upper or lower end of the entrance 127, and may include a shaft provided along a direction parallel to the base 121. The door 126 may be hingedly coupled to the inner wall 124 of the mounting unit 120.

The door 126 may be rotatable by the door driving unit 126a. For example, the door driving unit 126a may be a motor.

For example, the door 126 may be formed in a shape of a rectangular flat plate, and a hinge unit 126b may be provided at an upper end of the door and the door driving unit 126a may be connected to one axial end of the hinge unit 126b. At this time, the hinge unit 126b of the door 126 may be directly connected to the shaft of the door driving unit 126a, or may be connected thereto to transmit power through at least one gear.

The door 126 may be configured to maintain a closed state of the entrance 127 while the robot cleaner 200 is mounted on the mounting unit 120. When the robot cleaner 200 starts to drive from the mounting unit 120, the door may be rotated to open the entrance 127. After the robot cleaner 200 passes out the entrance 127, the door 126 may be rotated to close the entrance 127. In addition, the door 126 may be rotated to open the entrance 127 when the robot cleaner 200 approaches from the outside of the robot cleaner station 100.

The mounting unit 120 may include an accommodating space S, a base 121, a mounting wall 123, and an inner wall 124.

The accommodating space S of the mounting unit 120 may accommodate the robot cleaner 200. As one example, the accommodating space S may be a space surrounded by the base 121, the mounting wall 123, and the inner wall 124. As another example, the accommodating space S may be a space surrounded by the base 121, a washing plate 122, the mounting wall 122, and the inner wall 124. As a further example, the accommodating space S may be a space where the robot cleaner 200 is located while the robot cleaner 200 is connected to a power supply terminal 123b, or a space where the robot cleaner 200 is located while the dust bin 220 of the robot cleaner 200 is in communication with a dust passage hole 123a.

The base 121 may be disposed so that the robot cleaner station 100 is in contact with the floor, and configured to supply the robot cleaner 200 when the robot cleaner 200 is mounted to the robot cleaner station 100. The base 121 may include a base body 121a, an inclined portion 121b, a wheel coupling portion 121c, an agitator accommodating portion 121d, and a washing tank 128.

The base body 121a may defined the overall exterior of the base 121. The inclined portion 121b, the wheel coupling portion 121c, the agitator accommodating portion 121d, and the washing tank 128 may be disposed on the base body 121a.

The horizontal width or diameter (parallel to X and Y) of the base body 121a may greater than the vertical height (parallel to Z). With this configuration, there is an effect of stably supporting the robot cleaner station 100 on the bottom surface.

A circulation path may be provided inside the base body 121a. accordingly, the air discharged from the dust collection motor 145 may flow through the air circulation path formed in the base body 121a, and may be then discharged to the air reflux hole 125b.

The inclined portion 121b may be disposed at the entrance through which the robot cleaner 200 climbs in the base body 121a.

The inclined portion 121b may have a slope inclined upward to the front in the direction in which the robot cleaner 200 enters. More specifically, the front end of the inclined portion 121b toward the entrance may be connected so that there is no height difference with the ground, but may have a slope increasing as it faces the front in the direction in which the robot cleaner 200 enters. At this time, the direction in which the robot cleaner 200 enters means the rear with respect to the robot cleaner station 100. As a result, the robot cleaner 200 may easily climb up from the ground to the robot cleaner station 100.

A wheel guide portion 121ba may be provided in the inclined portion 121b.

The wheel guide portion 121ba may be provided in a shape of a groove configured to guide the movement of the wheel 260 of the robot cleaner 200. To allow the robot cleaner 200 to stably drive, the surface of the wheel guide portion 121ba may be formed to correspond to the surface of the wheel 260. In addition, the wheel guide portion 121ba may have the groove with the width greater than the width of the wheel 260, and the width of the groove may be formed to become narrower with respect to the entrance as moving toward along the climbing path of the robot cleaner 200. Accordingly, the wheel of the robot cleaner 200 may easily enter the robot cleaner station 100, but the wheel may be guided to the proper position because the left and right movement of the wheel 260 is limited by the grove having the width gradually becoming narrower.

An auxiliary wheel guide portion 121bb may be provided on the inclined portion 121b.

The auxiliary wheel guide portion 121bb may be formed in a shape of a groove guiding the movement of the auxiliary wheel 270 of the robot cleaner 200. In addition, the auxiliary wheel guide portion 121bb may be formed in a shape of a protrusion to come into contact with the auxiliary wheel 270 when the wheel 260 of the robot cleaner 200 is seated on the wheel guide portion 121ba. Accordingly, when driving on the inclined portion 121b, the robot cleaner 200 may be stably supported by the auxiliary wheel 270 as well as the wheel 260.

The wheel 260 of the robot cleaner 200 moving upward along the wheel guide portion 121ba may be seated on the wheel seating portion 121c. When the wheel 260 of the robot cleaner 200 is seated on the wheel coupling portion 121c, the physical connection between the robot cleaner 200 and the robot cleaner station 100 may be made. The surface of the wheel coupling portion 121c may be formed to correspond to the surface of the wheel 260 so that the robot cleaner 200 can be supported stably. The wheel coupling portion 121c may extend from the upper end of the wheel guide portion 121ba. The wheel coupling portion 121c may be connected with the wheel guide portion 121ba without steps. Accordingly, the robot cleaner 200 may easily move pass the inclined portion 121b to the wheel coupling portion 121c.

The wheel coupling portion 121c may be disposed at a stop position of the left and right wheels 260 of the robot cleaner 200 can stops at the proper position. Here, the stop position of the wheel 260 means a position at which the robot cleaner 200 is set to stop so as to be connected to the power supply terminal 123b and/or a position at which the dust bin 220 of the robot cleaner 200 is set to stop so as to be connected to the dust passage hole 123a.

The shape of the wheel coupling portion 121c may correspond to the shape of the wheel 260 of the robot cleaner 200, that is, an arch shape. With this configuration, the robot cleaner 200 may move along the wheel guide portion 121ba and stop at the same time as the wheel 260 is inserted into the wheel coupling portion 121c, and the wheel 260 can be stably seated on the arch-shaped wheel coupling portion 121c.

The agitator accommodating portion 121d may accommodate at least predetermined portion of the agitator 250 of the robot cleaner 200. Specifically, the agitator accommodating portion 121d may provide a space accommodating the agitator 250 of the robot cleaner 200 while the wheel 260 of the robot cleaner 200 is seated on the wheel coupling portion 121c.

The agitator accommodating portion 121d may be formed between the wheel coupling portions 121c. The agitator accommodating portion 121d may be formed in a shape corresponding to the agitator 250 of the robot cleaner 200. The agitator accommodating portion 121d may be formed in a rectangular parallelepiped shape with an open upper portion. The lower surface of the agitator accommodating portion 121d may be sealed by the bottom surface of the base body 121a or the bottom surface of the housing 110. Accordingly, the agitator 250 of the robot cleaner 200 that has moved upward along the inclined portion 121b may be settled into the recessed portion 121da through the open upper surface of the agitator accommodating portion 121d. At this time, the depth of the recessed portion 121da may be formed shallower than the depth of the wheel coupling portion 121c.

The agitator accommodating portion 121d may include a recessed portion 121da and a protruded portion 121db.

The recessed portion 121da may be recessed from the bottom member 121. The recessed portion 121da may form an accommodating space that accommodate at least some area of the agitator 250. Through this, at least some area of the agitator 250 may be accommodated in the accommodating space of the recessed portion 121da.

The accommodating space of the recessed portion 121da may be in communication with the accommodating space S of the mounting unit 120.

The protruded portion 121db may protrude from the base 121. The protruded portion 121db may be arranged along the edge of the recessed portion 121da. While the agitator 250 is accommodated in the accommodating space of the recessed portion 121da, the protruded portion 121db may be spaced apart a preset distance from the body 210 of the robot cleaner 200.

The protruded portion 121db may be configured to guide the air discharged through the air reflux hole 125b to the suction port 211 of the robot cleaner 200. Through this, the air discharged to the accommodating space of the recessed portion 121da may be guided to the suction port 211 of the robot cleaner 200 by the protruded portion 121db.

An air reflux hole 125b may be formed in the agitator accommodating portion 121d. The air reflux hole 125b may be formed on the side of the agitator accommodating portion 121d. The air reflux hole 125b may connect the recessed portion 121da and the dust collection motor 145 through a circulation path. The recessed portion 121da and the circulation path may be communicated through the air reflux hole 125b. Therefore, the air discharged from the dust collection motor 145 may pass through the air reflux hole 125b and be discharged to the recessed portion 121da of the agitator accommodating portion 121d.

The coupling wall 123 is configured to place the dust passage hole 123a, power supply terminal 123b, and water supply nozzle 123c of the robot cleaner station 100. The coupling wall 123 may spatially separate the accommodating space S from the components of the robot cleaner station 100. The coupling wall 123 may extend vertically from the rear side of the base 121. The coupling wall 123 may be formed to correspond to the shape of the robot cleaner 200. For example, when the cleaner body 210 of the robot cleaner 200 has a cylindrical shape, the coupling wall 123 may be formed in an arc shape with a predetermined radius. With this configuration, the outer surface of the robot cleaner 200 may be surrounded, and the area facing the outer surface of the robot cleaner 200 may be increased. Additionally, it can stably support the robot cleaner 200.

A dust passage hole 123a may be formed in the mounting unit 120 to allow air from outside the housing 110 to flow into the inside. Specifically, the dust passage hole 123a may be formed in the coupling wall 123 to allow air from outside the housing 110 to flow into the inside. The dust passage hole 123a may be communicated with the dust bin 220 of the robot cleaner 200. The dust passage hole 123a may be communicated with a dust discharge hole 221 of the dust bin 220 of the robot cleaner 200. The dust passage hole 123a may be formed in a hole shape corresponding to the shape of the dust bin 220 to allow dust from the dust bin 220 to flow into the dust collection unit 140. The dust passage hole 123a may be formed to correspond to the shape of the dust discharge port 221 of the dust bin 220. The dust passage hole 123a may be formed to communicate with the dust collection path 130. The air sucked into the dust passage hole 123a may flow through the dust collection path 130 and then be exhausted through the air reflux portion 125.

The robot cleaner station 100 may include a power supply module that supplies power to the robot cleaner 200. The power supply module may include a power supply module housing and a power supply terminal 123b, and a circuit board and components for power supply may be mounted within the power supply module housing. Furthermore, the power supply terminal 123b may be positioned forward of the power supply module housing, exposed on the coupling wall 123.

The power supply terminal 123b may supply power to the robot cleaner 200 coupled to the mounting unit 120. The power supply terminal 123b may be electrically connected by contact with the charging terminal of the robot cleaner 200. The power supply terminal 123b may be positioned on the mounting unit 120. Specifically, the power supply terminal 123b may be positioned on the coupling wall 123. The power supply terminal 123b may be electrically connected to the robot cleaner 200 coupled to the coupling wall 123. The power supply terminal 123b may supply power to the battery of the robot cleaner 200 coupled to the coupling wall 123.

The robot cleaner station 100 may further include a water supply nozzle 123c.

The water supply nozzle 123c may be connected to the supply portion 231 of the water tank 230 of the robot cleaner 200. Specifically, the water supply nozzle 123c may be connected to the inlet of the water tank 230. The inlet is configured to be connected to the water tank 230 of the robot cleaner 200. The water supply nozzle 123c can supply water supplied from the water supply pipe of the kitchen cabinet 2 to the storage space inside the water tank 230 of the robot cleaner 200.

The inner wall 124 is a configuration that spatially separates the receiving space (S) of the mounting unit 120 from the components of the robot cleaner station 100. A pair of inner walls 124 may be arranged on the left and right sides of the base 121. The inner walls 124 may be connected to both ends of the connecting wall 123. The inner walls 124 may extend in a direction intersecting the base 121 from the left and right sides of the base 121. Specifically, the inner walls 124 may extend vertically from the left and right sides of the base 121. The height of the inner walls 124 may correspond to the height of the pedestal 21. Specifically, the height of the inner wall 124 may be formed to be the same as the height of the pedestal 21.

Meanwhile, various components such as a dust collection path 130, a dust collection unit 140, a dust collection motor 145, a detergent container 163, and a waste container 164d may be arranged on the outer side of the inner wall 124. Specifically, the dust collection unit 140, the detergent container 163, and the waste container 164d may be accommodated in the space between the inner wall 124 and the outer wall 111 of the housing 110.

The dust collection unit 140 and the detergent container 163 may be separated from the space between the inner wall 124 and the outer wall 111 of the housing 110 in a sliding manner. The left-right width of the dust collection unit 140 and detergent container 163 may be formed to correspond to the distance between the inner wall 124 and the outer wall 111 of the housing 110.

The washing plate 122 is configured to clean the mop of the robot cleaner 200. The washing plate 122 may be mounted on the washing tank 128 of the base 121. Furthermore, the washing plate 122 may come into contact with the mop 242 while the robot cleaner 200 is mounted.

The washing plate 122 may be formed to slope downward toward the center.

Specifically, the washing plate 122 includes a curved flow guide surface 122c. Furthermore, at least one passage hole 122b through which a fluid can pass may be formed on the flow guide surface 122c. Furthermore, a washing protrusion 122a may be formed to protrude from the flow guide surface 122c.

At this time, a pair of washing protrusions 122a may be symmetrically formed on the flow guide surface 122c. Specifically, the pair of washing protrusions 122a may be arranged vertically below a pair of mops 242 of the robot cleaner 200, facing the pair of mops 242, and may be arranged so as to be in contact with at least a portion of the pair of mops 242.

In addition, a plurality of passage holes 122b may be formed on the flow guide surface 122c, and may be formed between a pair of washing protrusions 122a. For example, a plurality of passage holes 122b may be formed, including a position with the lowest height from the ground (kitchen floor) among the flow guide surface 122c, and may be formed between a pair of washing protrusions 122a. Through this, the fluid discharged between the pair of washing protrusions 122a may be guided and flow into the passage hole 122b.

Meanwhile, the height of the flow guide surface 122c from the kitchen floor may increase as it moves rearward from the position where the passage hole 122b is formed. That is, the height of the flow guide surface 122c from the kitchen floor may increase as it approaches the external air discharge unit 171c, which will be described later.

With this configuration, the wash water and/or air may be guided in flow by the flow guide surface 122c and may escape into the space formed between the washing plate 122 and the washing tank 128 through the passage hole 122b. Through this, heated air may pass through the passage hole 122b and be supplied to the washing tank 128.

Therefore, when the driving unit of the rotary cleaning unit 240 is driven while the mop 242 of the robot cleaner 200 is placed on the washing plate 122, the mop 242 rotates. At this time, when the mop 242 rotates while wash water is supplied to the washing plate, the mop 242 may be washed by rubbing against the washing protrusion 122a that is in a stationary state.

The washing tank 128 is configured to accommodate the washing plate 122. The washing tank 128 may be positioned on the rear side of the base body 121a. The washing tank 128 is positioned below the washing plate 122 and is detachably coupled to the washing plate 122. The washing tank 128 may be formed to correspond to the washing plate 122 so that the washing plate 122 may be inserted therein. Liquid passing through the washing plate 122 may flow into the washing tank 128.

The washing tank 128 may include a washing tank base surface through which the fluid passing through the washing plate 122 flows, and a washing tank wall that protrudes vertically from the outer edge of the washing tank base surface. At this time, the height of the washing tank base surface from the ground (kitchen floor) may decrease as it moves toward the rear of the robot cleaner station 100. Through this, the fluid that has passed through the washing plate 122 may be collected at the rear of the washing tank 128 and discharged to the outside through the waste water inlet 164c described later.

### Dust collection unit:

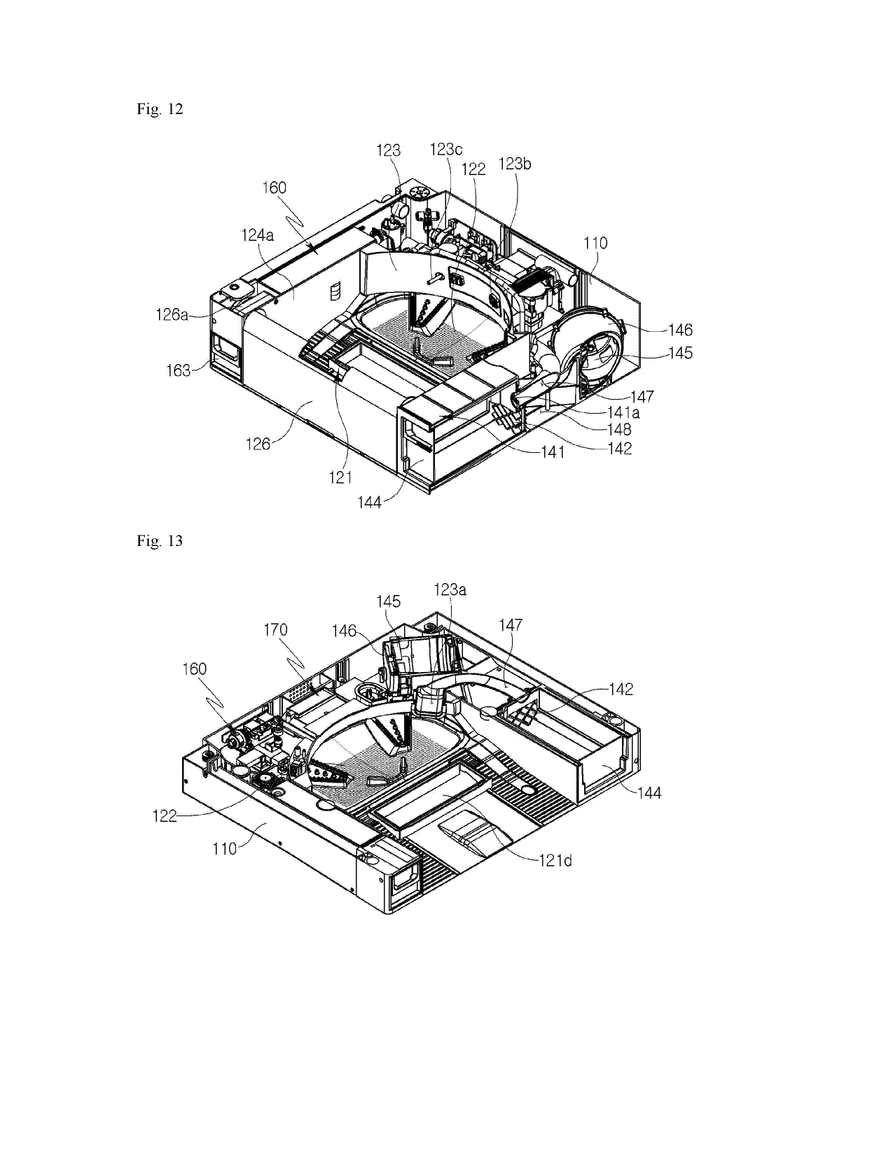

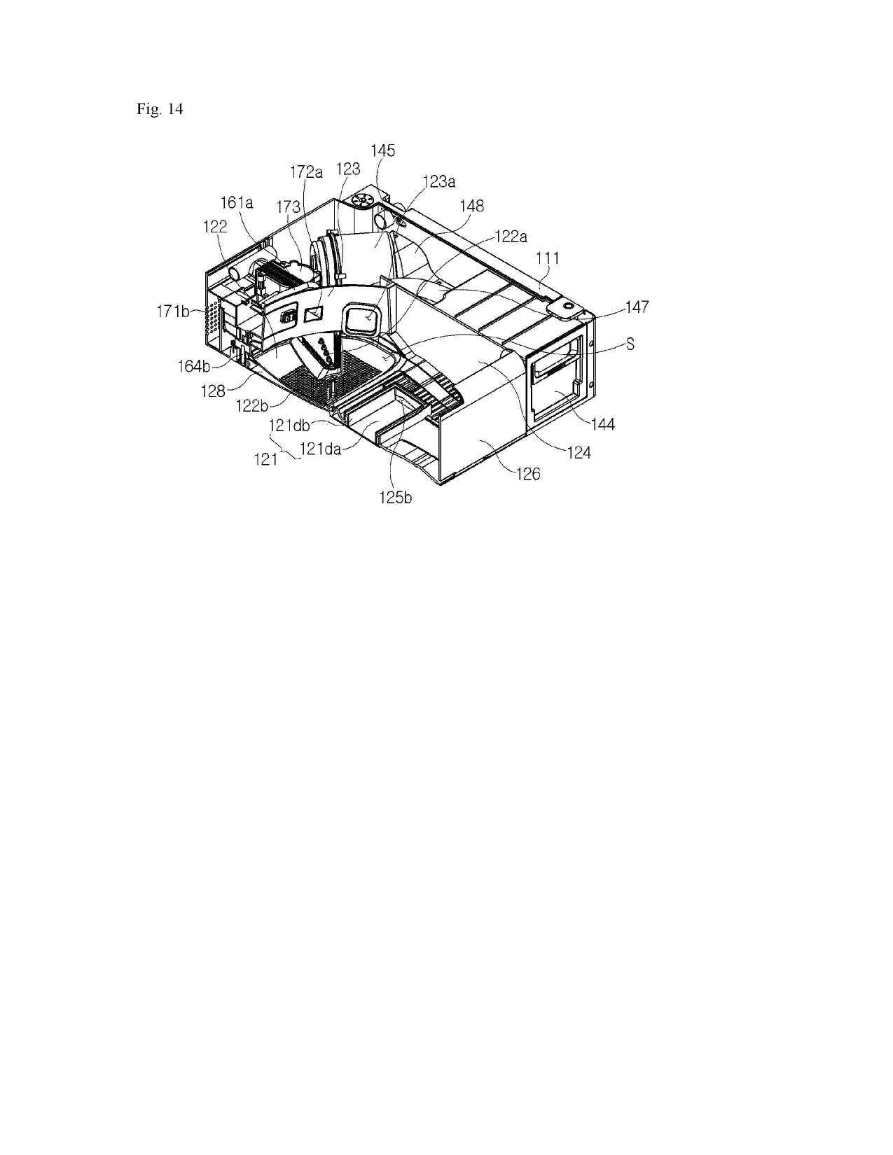

FIGS. 12 and 13 are side views to describe a dust collection path of the robot cleaner station according to embodiments of the present disclosure. FIG. 14 is a cross-sectional view to describe a dust collection path of a robot cleaner station according to embodiments of the present disclosure.

Referring to FIGS. 12 to 14 and FIG. 17, the dust collection unit 140 will be described as follows.

The dust collection unit 140 may collect dust from the dust bin 220 of the robot cleaner 200. The dust collection unit 140 may be placed inside the housing 110. The dust collection unit 140 may be placed outside the mounting unit 120. At this time, the accommodating space (S) may be placed inside the mounting unit 120.

The dust collection unit 140 may include a dust collection unit housing 141, a dust bag (not shown), a filter 142, and a dust bag drawer 144.

The dust collection unit housing 141 may define a space that may accommodate a dust bag (not show), the filter 142, and the dust bag drawer 144.

The dust collection unit drawer 144 may be withdrawably coupled to the dust collection unit housing 141 so that the dust bag drawer 144 can be withdrawn, and the dust bag (not shown) may be stored inside the dust bag drawer 144. For example, the dust collection unit housing 141 may be formed in a rectangular pipe shape with an open front and a rear inner space may be connected to the first dust collection path 147 and the second dust collection path 148.

The inner one side of the dust collection unit housing 141 may be connected to the first dust collection path 147 and the other side thereof may be connected to the second dust collection path 148. In addition, when the dust bag (not shown) is coupled to the dust collection unit housing 141, the dust bag (not shown) may be in communication with the first dust collection path 147 within the dust collection unit housing 141.

The dust bag (not shown) may mean a dust bag in which dust sucked from the dust bin 220 of the robot cleaner 200 is collected by the dust collection motor 145. The dust bag (not shown) may be detachably coupled to the dust collection unit housing 141. Accordingly, the dust bag (not shown) may be detached from the dust collection unit housing 141 and discarded, and a new dust bag (not shown) may be attached to the dust collection unit housing 141. That is, the dust bag (not shown) may be defined as a consumable part.

The dust bag (not shown) may be configured to receive dust therein as its volume increases, when suction power is generated by the dust collection motor 145.

To this regard, the dust bag (not shown) may be made of a material that is permeable to air but impermeable to foreign substances such as dust. For example, the dust bag (not shown) may be made of a non-woven material, and may have a hexahedral shape equal to the shape of the dust collection unit housing 141 when its volume increases.

The filter 142 may be disposed between the dust collection unit housing 141 and the second dust collection path 148. The filter 142 may be provided at the outlet hole 141b. the filter 142 may be a pre-filter or a HEPA filter. Air passing through the dust bag (not shown) may pass through the filter 142 and flow into the second dust collection path 148.

The dust bag drawer 144 may be withdrawably coupled to the dust collection unit housing141, and the dust bag (not shown) may be provided in the dust bag drawer 144.

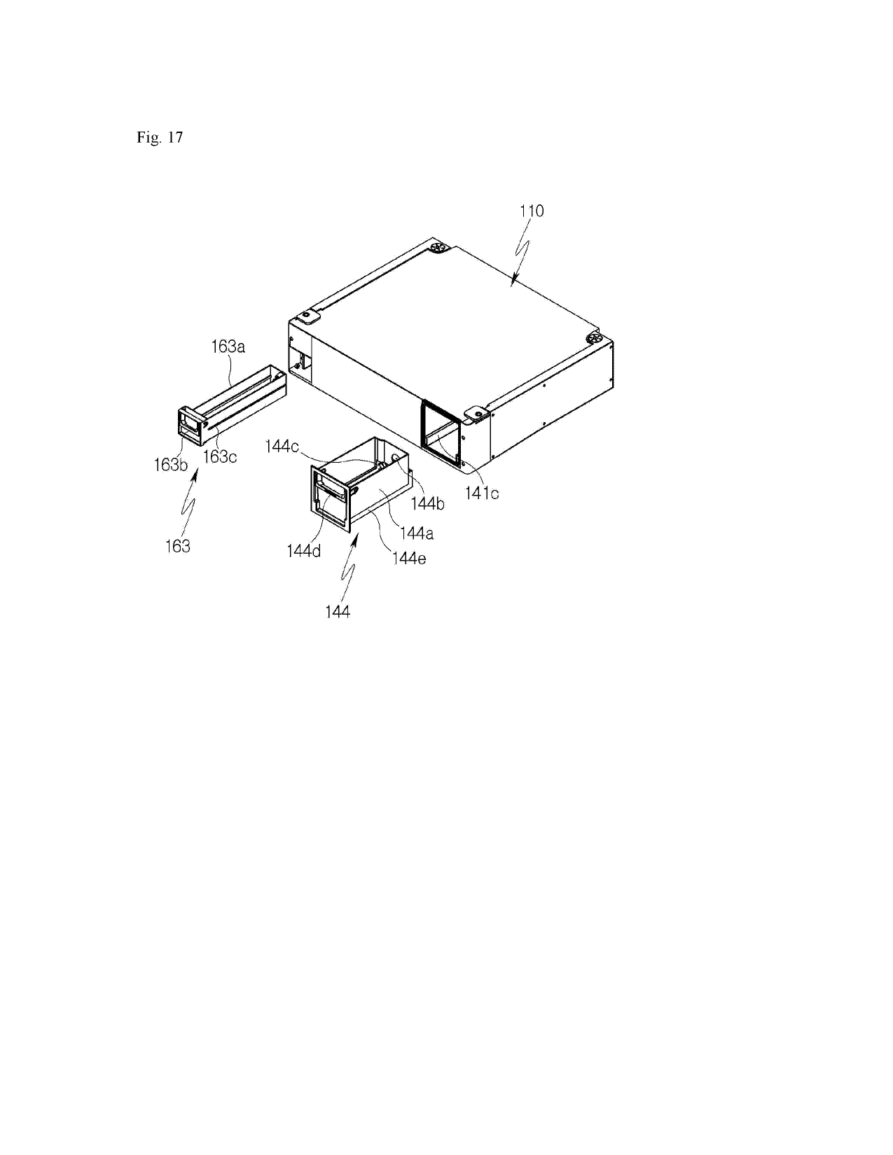

At this time, referring to FIG. 17, the dust bag drawer 144 may include a dust back drawer body 144a, a handle 144d, and a drawer rail 144e.

The dust back drawer 144a may provide a space in which the dust bag (not shown) can be coupled. For example, the dust back drawer body 144a may be formed in a box shape with an open top, and an inlet 144b and an outlet 144c may be formed in the rear to connect the dust bag drawer body with the first dust collection path 147 and the second dust collection path 148.

For example, the dust bag drawer body 144e may be formed with different widths in the upper left-right direction and the lower left-right direction. That is, the inside of the dust bag drawer body 144a may be formed with a step. Through this, the upper space where the dust bag (not shown) is provided may be maximized, and a path through which air can easily escape downward after passing through the dust bag (not shown).

The upper portion of the dust bag drawer body 144a may be connected with the first dust collection path 147 through the inlet 144b. the inlet 144b may be configured to guide air flowing through the first dust collection path 147 into the dust bag (not shown). The inlet 144b may connect the first dust collection path 147 and the dust bag (not shown) with each other. Accordingly, dust sucked from the dust bin 220 of the robot cleaner 200 may be moved into the dust bag (not shown) after passing through the first dust collection path 147 and the inlet 144b.

The dust drawer 144 may be connected with the second dust collection path 148 through the outlet 144c formed in the lower portion of the lateral surface. The outlet 144c may be configured to guide air having passed through the dust bag drawer 144 to the second dust collection path 148. The outlet 144 may be positioned lower than the inlet 144b. the outlet 144c may connect the inner space of the dust bag drawer 144 with the second dust collection path 148. Accordingly, the air having dust filtered therefrom while passing through the dust bag (not shown) may be moved to the second dust collection path 148 through the outlet 144c.

The handle 144d may be provided on the front of the dust bag drawer body 144a. The handle 144d may be provided so that the user can grip. For example, the handle 144d may include a pair of coupling portions hingedly coupled to the front surface of the dust bag drawer body 144a, and a gripping portion formed by coupling the pair of coupling portions so that the user can grip it.

With this configuration, when the user grips the gripping portion and pulls it forward, the dust bag drawer body 144a may be pulled forward together and taken out. Accordingly, according to the present disclosure, the user can easily pull the dust bag drawer 144 forward and then lift the dust back (not shown) upward to remove and replace it.

The drawer rail 144e may be formed on each of the left and right surfaces of the dust bag drawer body 144a. The drawer rail 144e may be configured to guide the movement of the dust bag drawer body 144a.

For example, the drawer rail 144e may be formed in a shape of a groove or rib formed on each of the left and right surfaces of the dust bag body 144a along the front-back direction.

With this configuration, when the user couples the dust bag drawer 144 to the dust collection unit housing 141, he or she can couple them at the correct position and connect the first dust collection path 147 and the second dust collection path 148 at the correct position, thereby reducing flow loss.

Meanwhile, corresponding to the drawer rail 144e, a rail 141c may be formed on the inner lateral surface of the dust collection unit housing 141. The rail 141c of the dust collection unit housing 141 may be formed with the same shape and size as the shape of the drawer rail 144e. For example, when the drawer rail 144e is formed in a groove shape, the dust collection unit housing 141 may be formed in a shape of a rib or protrusion.

The robot cleaner station 100 may include the dust collection path 130. The dust collection path 130 may mean a path through which air sucked through the dust passage hole 123a flows through the dust collection unit 140 and reaches the dust collection motor 145.

Specifically, when the robot cleaner 200 is mounted to the robot cleaner station 100 and the dust passage hole 123a is connected to the dust bin 220 of the robot cleaner 200, the dust collection path may include the first dust collection path 147 connecting the dust bin 220 and the dust collection unit 140, and the second dust collection path 148 connecting the dust collection unit 140 and the dust collection motor 145.

The first dust collection path may connect the dust bin 220 of the robot cleaner 200 and the dust collection unit 140 with each other. The first dust collection path 147 may make the dust bin 220 of the robot cleaner 200 and the dust collection unit 140 communicate with each other. The first dust collection path 147 may mean a space formed between the dust bin 220 of the robot cleaner 200 and the dust collection unit 140. The first dust collection path 147 may be formed close to the horizontal direction. The first dust collection path 147 may be a space formed toward the rear from the dust passage hole 123a, and may be a flow path formed by bending toward the lateral surface from the dust passage hole 123a. Through the first dust collection path 147, dust inside the dust bin 220 of the robot cleaner 200 can move to the dust collection unit 140.

The second dust collection path 148 may connect the dust collection unit 140 and the dust collection motor 145 with each other. The second dust collection path 148 may be formed close to the horizontal direction. At this time, the first dust collection path 147 and the second dust collection path 148 may be formed at different heights. The first dust collection path 147 and the second dust collection path 148 may be formed in a laminated structure. The second dust collection path 148 may be disposed lower than the first dust collection path 147. With this configuration, the left-right width and overall volume of the robot cleaner station 100 may be minimized.

The dust collection module may be configured to provide suction airflow to the dust collection path.

Specifically, the dust collection module may include a dust collection motor housing 146 and a dust collection motor 145.

The dust collection motor housing 146 may be disposed inside the housing 110. The dust collection motor housing 146 may accommodate the dust collection motor 145.

The inner space of the dust collection motor housing 146 may be connected to the second dust collection path 148. Accordingly, air flowing through the second dust collection path 1132 may be guided toward the dust collection motor 145.

The inner space of the dust collection motor housing 146 may be connected to the air circulation path. Accordingly, air may be guided to the air circulation path after passing the dust collection motor 145.

The dust collection motor 145 may be configured to generate suction force in the dust collection path.

The dust collection motor 145 may be disposed in the rear of the dust collection unit housing 141. Through this, the dust collection motor 145 may provide suction power for sucking up dust in the dust bin 220 of the robot cleaner 200.

The dust collection motor 145 may be configured to generate suction power by rotation. For example, the dust collection motor 145 may be formed in a shape similar to a cylinder.

The dust collection motor 145 may have one side connected to the second dust collection path 148 and the other side connected to the air circulation path. when the dust collection motor 145 is driven, air flowing through the second dust collection path 148 may flow into the dust collection motor housing 146. The air introduced into the dust collection motor housing 146 may pass through the dust collection motor 145 and the circulation path. then, the air may be discharge to the air reflux hole 125b.

Meanwhile, a rotation axis of the dust collection motor 145 may be formed close to the horizontal direction. With this configuration, the overall volume of the robot cleaner station 100 disposed in the kitchen cabinet 2 or the mounting space 21a of the structure may be minimized.

Meanwhile, according to the embodiment, the rotation axis of the dust collecting motor 145 may be arranged along the vertical direction. In this case, the horizontal space occupied by the dust collection motor 145 may be minimized.

The air reflux portion 125 may be configured to guide air discharged from the dust collection motor 145 to the robot cleaner 200.

The air discharge part 125 may include a circulation path and an air reflux hole 125b.

The air circulation path may provide a path through which air discharged from the dust collection motor 145 can flow. The circulation path may be disposed inside the base body 121a.

The air circulation path may be connected to the dust collection motor 145. The air circulation path may mean a path connecting the inner space of the motor housing 151 and the air reflux hole 125b. One end of the air circulation path may be in communication with the inner space of the dust collection motor housing and the other end thereof may be in communication with the accommodating space of the recessed portion 121da.

The air circulation path may be a path formed within the housing 110 along the horizontal direction. The air circulation path may be connected to the dust collection motor 145. Specifically, one end of the air circulation path may be in communication with the inner space of the dust collection motor housing 146 and the other end thereof may be in communication with the air reflux hole 125b.

The air reflux hole 125b may serve as an outlet configured to guide air discharged from the dust collection motor 145 to the accommodating space of the recessed portion 121da.

The air reflux hole 125b may be formed on the base 121. The air reflux hole 125b may be formed in the agitator accommodating portion 121d. The air reflux hole 125b may be formed in the lateral wall of the recessed portion 121da.

The air circulation path according to an embodiment of the present disclosure may guide the air discharged from the dust collection motor 145 to the suction port 211 of the robot cleaner 200.

The air circulation path may create a structure in which the air discharged from the dust collection motor 145 is not discharged to the outside but is guided to the suction port 211 of the robot cleaner 200, thereby continuously circulating between the robot cleaner 200 and the robot cleaner station 100. As a result, the heat discharged from the dust collection motor 145 is not discharged to the kitchen cabinet 2, but is re-introduced into the interior of the robot cleaner 200 and circulated, thereby preventing damage to the interior of the kitchen cabinet 2.

The air passing through the dust collection motor 145 is discharged into the accommodating space S through the air reflux hole 125b, and the air discharged into the accommodating space S may be re-introduced into the suction port 211 due to the suction force of the dust collection motor 145. Therefore, the air sucked in from the dust bin 220 by the suction force of the dust collection motor 145 may flow in sequence through the dust passage hole 123a, the first dust collection path 147, the dust collection unit housing 141, the second dust collection path 148, the dust collection motor 145, the circulation path, and the air reflux hole 125b, and then be discharged into the accommodating space (S).

At this time, the dust collection motor 145 may be driven together when the suction motor (not shown) of the robot cleaner 200 is driven. The air exhausted through the air reflux hole 125b is sucked into the suction port 211 by the suction power of the suction motor (not shown) in addition to the dust collection motor 145, so that the dust collection efficiency can be improved.

### Mop washing unit:

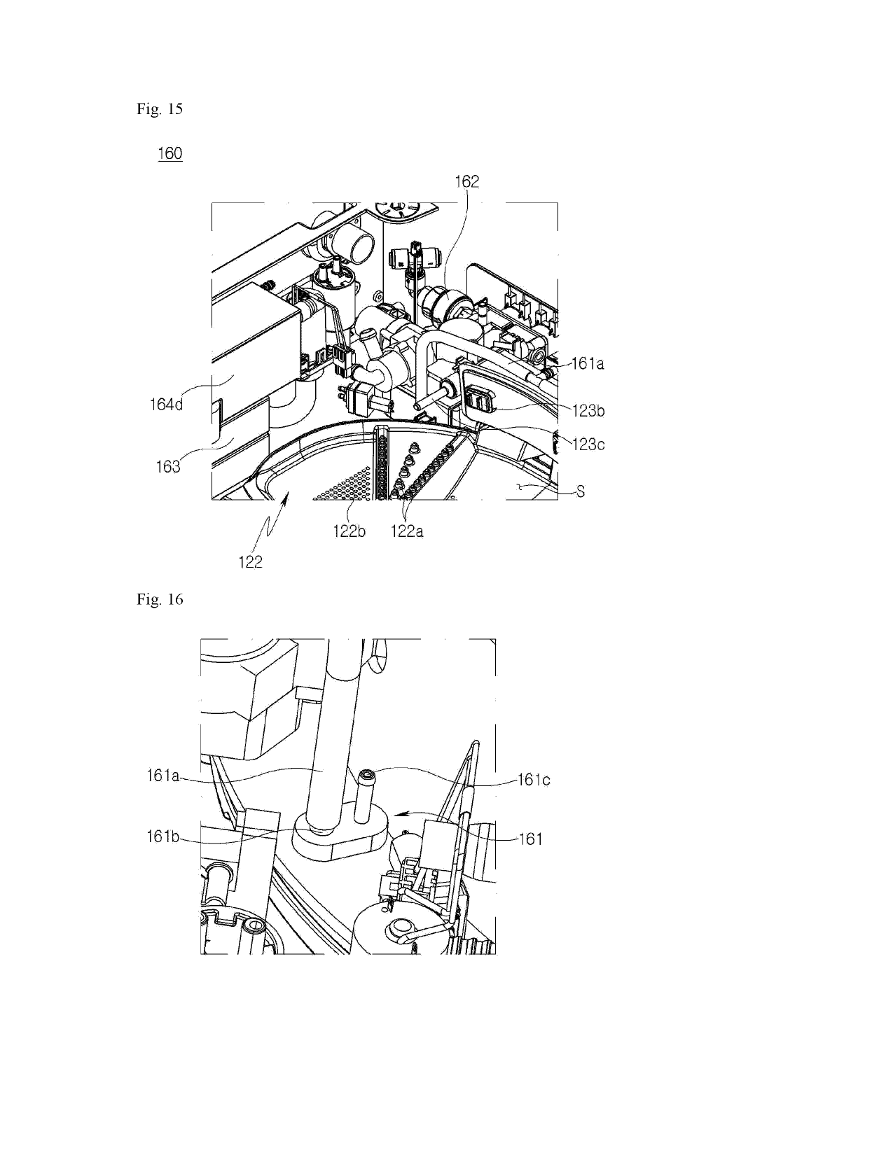

FIG. 15 is an enlarged view showing a mop washing unit of a robot cleaner station according to an embodiment of the present disclosure. FIG. 16 is an enlarged view illustrating a wash water supply unit of a mop washing unit of a robot cleaner station according to an embodiment of the present invention. FIG. 17 is a view showing a state in which a dust collection unit and a detergent container are withdrawn from a robot cleaner station according to an embodiment of the present disclosure.

Referring to FIGS. 15 to 17, the mop washing unit 160 of the robot cleaner station 100 according to an embodiment of the present disclosure will be described as follows.

The robot cleaner station 100 according to an embodiment of the present disclosure may include the mop washing unit 160. The mop washing unit 160 may wash the mop 242 of the robot cleaner 200 coupled to the mounting unit 120.

The mop washing unit 160 may include a wash water supply unit 161 that discharges wash water to the washing plate 122, a detergent container 163 that stores liquid including detergent, and a waste water container 164d that stores wash water from the mop 242.

In the wash water supply unit 161, purified water and detergent can be mixed to produce wash water for washing the mop 242.

The wash water supply unit 161 includes a branch flow path 161a, a purified water inlet 161b, a detergent inlet 161c, a detergent pump 161d, and a wash water nozzle (not shown).

At this time, the wash water nozzles (not shown) may be spaced apart from each other on the rear side of the coupling wall 123. The wash water nozzles (not shown) may discharge wash water toward the washing plate 122 from the upper side of the washing plate 122. For example, a pair of wash water nozzles (not shown) may be placed above a pair of washing protrusions 122a.

At this time, purified water supplied from the water supply pipe of the kitchen cabinet 2 and passing through the regulator 162 may be branched to both sides through the branch flow path 161a and connected to respective spaced-apart wash water nozzles (not shown). That is, the branch flow path 161a may be formed in the form of a single pipe branching into two, and at this time, one end of the branch may be connected to one of a pair of wash water nozzles (not shown), and the other end of the branch may be connected to the other of the pair of wash water nozzles (not shown). Accordingly, the branch flow path 161a may supply wash water to a pair of wash water nozzles (not shown).

The wash water nozzle (not shown) may be formed integrally with the coupling wall 123 at the rear side of the coupling wall 123, or may be detachably connected to the coupling wall 123.

The purified water inlet 161b is configured to guide purified water supplied from the water supply pipe of the kitchen cabinet 2 to the wash water supply unit 161. Specifically, the water supply pipe of the kitchen cabinet 2 is connected to the regulator 162, so that the flow rate supplied from the water supply pipe can be adjusted. In addition, a portion of the purified water that has passed through the regulator 162 may be supplied to the water tank 230 of the robot cleaner 200 through the water supply nozzle 123c, and the remainder can be introduced into a pair of wash water supply units 161 that are spaced apart from each other through the purified water inlet 161b.

The detergent inlet 161c is configured to guide the detergent-containing liquid supplied from the detergent container 163 to the wash water supply unit 161. Specifically, the detergent-containing liquid stored in the detergent container 163 may be supplied to the wash water supply unit 161 via the detergent pump 161d.

In addition, the detergent and purified water introduced into the wash water supply unit 161 may be mixed and utilized as wash water. The wash water supply unit 161 may discharge wash water onto the upper surface of the washing plate 122 through a wash water nozzle (not shown). The wash water nozzle (not shown) can be opened in a direction facing the upper surface of the mop 242 mounted on the washing plate 122.

The detergent container 163 may store a detergent-containing liquid.

The detergent container 163 includes a detergent container body 163a, a handle 163b, and a detergent container rail 163c (see FIG. 17).

The detergent container body 163a may provide a space for storing liquid, including detergent. For example, the detergent container body 163a may be formed in a box shape with an open top, and the rear may be connected to the wash water supply unit 161.

The handle 163b may be provided at the front of the detergent container body 163a. The handle 163b may be provided so that a user can grip it. For example, the handle 163b may include a pair of connecting portions hingedly connected to the front surface of the detergent container body 163a, and a grip portion formed by connecting the pair of connecting portions so that a user can grip it.

With this configuration, when a user grasps the grip and pulls forward, the detergent container body 163a may be pulled forward and withdrawn. Therefore, according to the present invention, a user can easily pull the detergent container 163 forward, and then supply detergent.

The detergent container rail 163c may be formed on the left and right sides of the detergent container body 163a. The detergent container rail 163c may guide the movement of the detergent container body 163a.

For example, the detergent container rail 163c may be formed in the form of a groove or rib along the front-back direction on the left and right sides of the detergent container body 163a.

With this configuration, when a user couples the detergent container 163 to the housing 110, it can be attached in the correct position, and wash water may be prevented from leaking out.

Meanwhile, although not shown, a rail may be formed in the housing 110 corresponding to the detergent container rail 163c. The above rail may be formed corresponding to the shape and position of the detergent container rail 163c.

The wastewater tank 164d can provide a space for storing the wash water used to wash the mop 242. The wash water discharged to the upper surface of the washing plate 122 may be drained through the passage hole 122b while descending along the slope of the washing plate 122 after washing the mop 242. The wash water passing through the passage hole 122b accumulates in the washing tank 128. In addition, the wash water accumulated in the washing tank 128 may flow into the wastewater suction path 164b through the wastewater inlet 164c and may flow into the wastewater tank 164d through the wastewater inlet path 164b. That is, the liquid passing through the washing plate 122 may flow along the washing tank 128 and be discharged through the wastewater inlet 164c.

Meanwhile, a wastewater suction path 164b is formed in a wastewater suction pipe, and the wastewater inlet 164c is formed at one end of the wastewater suction pipe, and the other end of the wastewater suction pipe is connected to the wastewater tank 164d. At this time, the wastewater suction pipe may be arranged to pass through the lower side of the external air supply module 171. That is, the wastewater suction path 164b may be arranged at the lower side of the external air supply module 171. In addition, the wastewater suction channel 164b may be arranged at the lower side of the external air supply path 171a.

Wash water stored in the wastewater tank 164d may be drained to the drain pipe 25 of the kitchen cabinet 2 through the wastewater discharge path 164a. One end of the wastewater discharge path 164a is connected to a fitting portion 192 arranged on the outer wall 111 of the housing 110, and the fitting portion 192 may be connected to the wastewater tank 164d through a drain connection pipe 164f and a drain connection module 165. The other end of the wastewater discharge path 164a may be connected to the drain pipe 25. At this time, the wash water stored in the wastewater tank 164d may be drained to the drain pipe by flowing through the wastewater discharge path (164a) by a centrifugal pump (not shown).

The wastewater discharge path 164a connected to the wastewater tank 164d may be connected to the upstream 25b based on the drain trap 25a of the drain pipe 25 of the kitchen cabinet 2. This is because, when the wastewater discharge path 164a is connected downstream 25c from the drain trap 25a of the drain pipe 25, foul odors or fluids inside the drain pipe 25 may flow back into the wastewater discharge path 164a.

In addition, the mop washing unit 160 may include a check valve (not shown). The check valve may prevent the fluid inside the drain pipe 25 from flowing back into the wastewater discharge path 164a. The check valve may be provided at the other end of the wastewater discharge channel 164a connected to the drain pipe 25.

Meanwhile, the detergent container 163 and the wastewater tank 164d may be accommodated in a space formed between the inner wall 124 and the outer wall 111 of the housing. The detergent container 163 may be placed on the lower side of the space between the inner wall 124 and the outer wall 111 of the housing, and the waste water container 164d may be placed on the upper side of the detergent container 163 in the space between the inner wall 124 and the outer wall 111 of the housing.

### Mop drying unit:

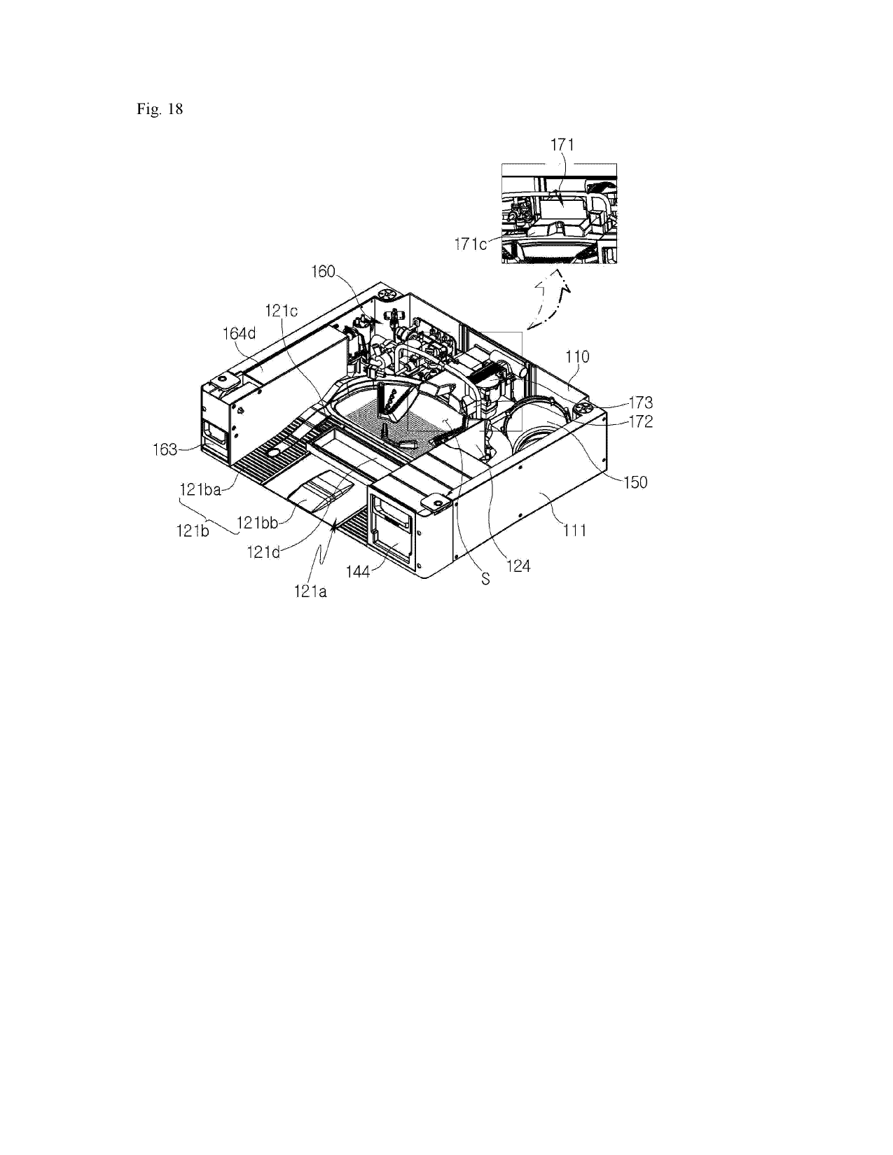

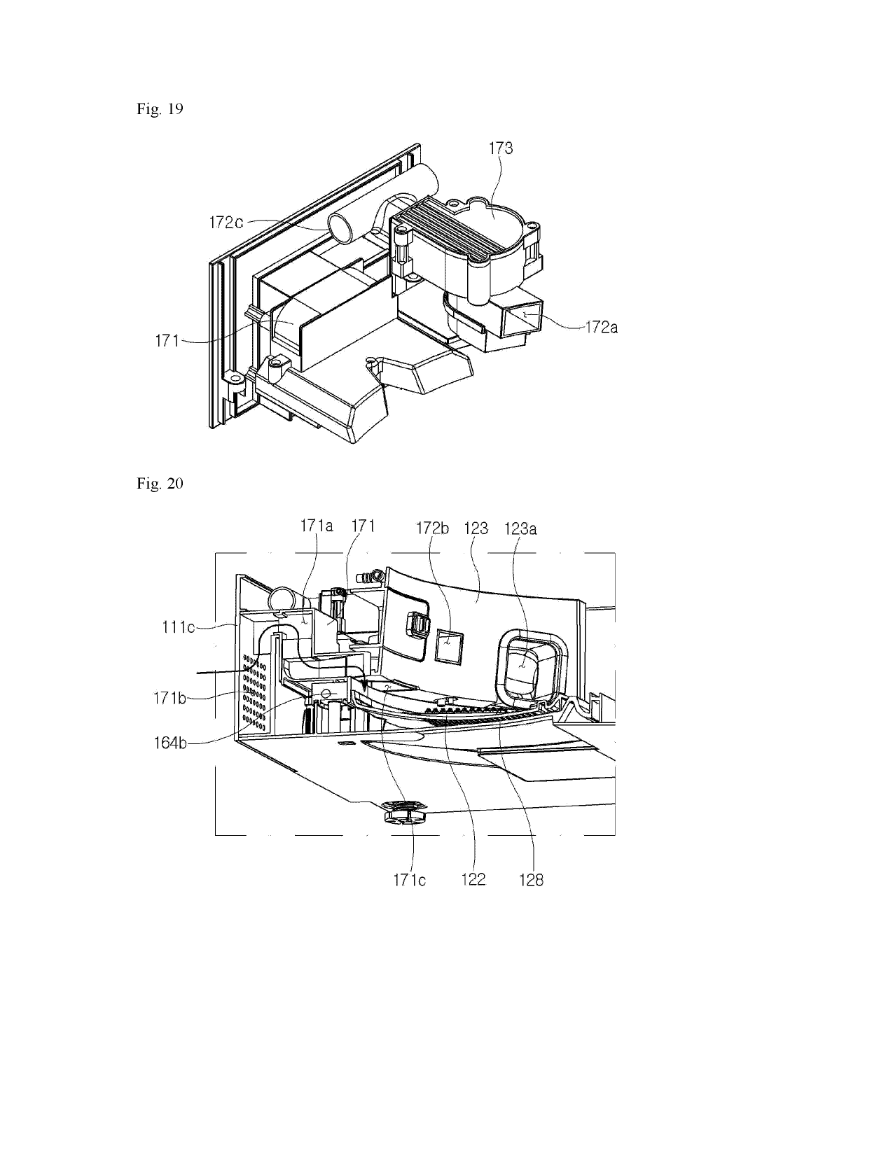

FIG. 18 is a perspective view showing a mop drying unit of a robot cleaner station according to an embodiment of the present disclosure. FIG. 19 is an enlarged view of a mop drying unit of the robot cleaner station according to an embodiment of the present disclosure. FIG. 20 is a cross-sectional view to describe air that flows into an external air supply module according to an embodiment of the present disclosure.

Referring to FIGS. 18 to 20, the robot cleaner station 100 according to one embodiment of the present disclosure may include a mop drying unit 170. At this time, the mop drying unit 170 may dry the mop 242 of the robot cleaner 200 that has been washed by the mop washing unit 160 or the mop 242 that is wet after a water cleaning task is completed.

The mop drying unit 170 according to one embodiment of the present disclosure may include an external air supply module 171, an air discharge unit 172, an exhaust fan 173, and a check valve 175.

The external air supply module 171 may supply heat to the accommodating space (S) and can include an outside air supply path 171a, an external air inlet 171b, an external air outlet 171c, a heater 171d, and a blower fan 171e.

The external air supply module 171 is formed with the external air supply path 171a. The external air supply path 171a may cause outside air to flow to the outside air outlet 171c.

The external air supply path 171a may connect the outside space of the housing 110 and the accommodating space (S). One side of the external air supply path 171a may be connected to an outside space through the external air inlet 171b, and the other side of the external air supply path 171a may be connected to the accommodating space (S) through the external air outlet 171c.

The external air inlet 171b may be formed on the rear surface of the housing 110. A plurality of external air inlets 171b may be formed on the rear surface of the housing 110. Air from outside the housing 110 may be introduced into the external air supply path 171a through the external air inlets 171b. Therefore, air from outside the housing 110 may be introduced into the interior of the housing 110.

At least a portion of the external air outlet 171c may be disposed above the washing plate 122. The external air outlet 171c may be opened in a direction facing the washing plate 122. The pair of external air outlets 171c may be provided, each open downward.

The external air outlet 171c may discharge air that has passed through the external air supply path 171a. The external air outlet 171c may discharge air heated by the heater 171d). For example, the external air outlet may be formed in the external air outlet 171c.

With the mop 242 mounted to the washing plate 122, the external air outlet 171c may be opened toward the upper side of the mop 242. Accordingly, the external air outlet 171c is positioned adjacent to the mop 242 and opens downward, allowing air discharged from the external air outlet 171c to flow toward the mop 242.

The blower fan 171e is positioned on the external air supply path 171a and may blow air toward the accommodating space (S). When the blower fan 171e is driven, air drawn in through the external air inlet 171b may be heated by the heater 171d and discharged into the accommodating space (S) through the external air outlet 171c.

The heater 171d is positioned on the external air supply path 171a and may heat the air flowing through the external air supply path 171a. The heater 171d may heat the air discharged through the external air outlet 171c.

The heater 171d may include a heater housing and a heating element. The heater housing may be positioned on the external air supply path 171a and may have a space provided therein to accommodate the heating element. Furthermore, the heating element may heat the air flowing into the heater housing. Therefore, air heated by the heating element is discharged through the external air outlet 171c to the accommodating space (S), thereby drying the wet mop 242.

The air discharge unit 172 may discharge the hot and humid air inside the robot cleaner station 100 generated while drying the mop 242 to the drain pipe 25. Specifically, the air discharge unit 172 may connect the accommodating space (S) and the drain pipe 25 of the kitchen cabinet 2. The air discharge unit 172 may exhaust the air in the accommodating space (S) to the outside.

An air discharge path may be formed in the air discharge unit 172. At this time, one end of the air exhaust path may be connected to the accommodating space (S), and the other end may be connected to the drain pipe 25. Specifically, one end of the air exhaust path, an air suction hole 172a, may be connected to the accommodating space (S), and the other end may be connected to the drain pipe 25. The air exhaust path may discharge air sucked in from the air suction hole 172a.

Meanwhile, the air suction hole 172a may be positioned at various locations on the accommodating space (S). The air suction hole 172a may be in communication with the accommodating space (S). For example, the air suction hole 172a may be positioned on the coupling wall 123. As another example, the air suction hole 172a may be positioned on the inner wall 124. As another example, the air suction hole 172a may be positioned higher from the ground than the mop 242, but may be positioned forward of the outside air discharge unit 171c. This allows air containing steam generated during the drying process of the mop 242 to be discharged.

The air discharge unit 172 may be connected downstream 25c of the drain pipe 25 of the kitchen cabinet 2 based on the oil trap 25a. This is because, when the air discharge unit 172 is connected upstream 25b of the oil trap 25a of the drain pipe 25, the heat exhausted through the air discharge unit 172 may not pass through the drain pipe 25 due to water accumulated in the oil trap 25a.

Meanwhile, the air discharge pipe 172c according to one embodiment of the present disclosure may be formed by branching one pipe into two inside the housing 110 and penetrating both sides of the housing 110. At this time, one of the branches may penetrate the left outer wall 111c of the housing 110, and the other branch may penetrate the right outer wall 111d of the housing 110. The air discharge unit 172 penetrating the outer walls 111 on both sides of the housing 110 may be connected to the drain pipe 25. Therefore, the air sucked in from the air discharge unit 172 may flow through the air discharge pipe 172c branched to both sides and be exhausted downstream 25c based on the oil trap 25a of the drain pipe 25. More specifically, when the drain pipe 25 is located on the left side of the robot cleaner station 100, the air can flow along the side that passes through the left outer wall 111c of the branched air discharge pipe 172c. On the other hand, when the drain pipe 25 is located on the right side of the robot cleaner station 100, the air can flow along the side that passes through the left outer wall 111c of the branched air discharge pipe 172c.

The exhaust fan 173 may exhaust air drawn in through the air suction hole 172a to the drain pipe 25. The exhaust fan 173 may cause air to flow through the air discharge unit 172. The exhaust fan 173 may be positioned on the air discharge path.

When the exhaust fan 173 is driven, air in the accommodating space (S) may be drawn in through the air suction hole 172a. The air drawn in through the air suction hole 172a may flow through the air discharge unit 172 and be exhausted through the drain pipe 25. Specifically, when the exhaust fan 173 is driven, the air flowing through the air discharge unit 172 may be exhausted downstream 25c based on the oil trap 25a of the drain pipe 25.

The mop drying unit 170 may include a check valve 175. The check valve 175 may be provided at the other end of an air discharge pipe 172c connected to the drain pipe 25. Through this, the fluid inside the drain pipe 25 may be prevented from flowing back into the air discharge unit 172.

### Layout:

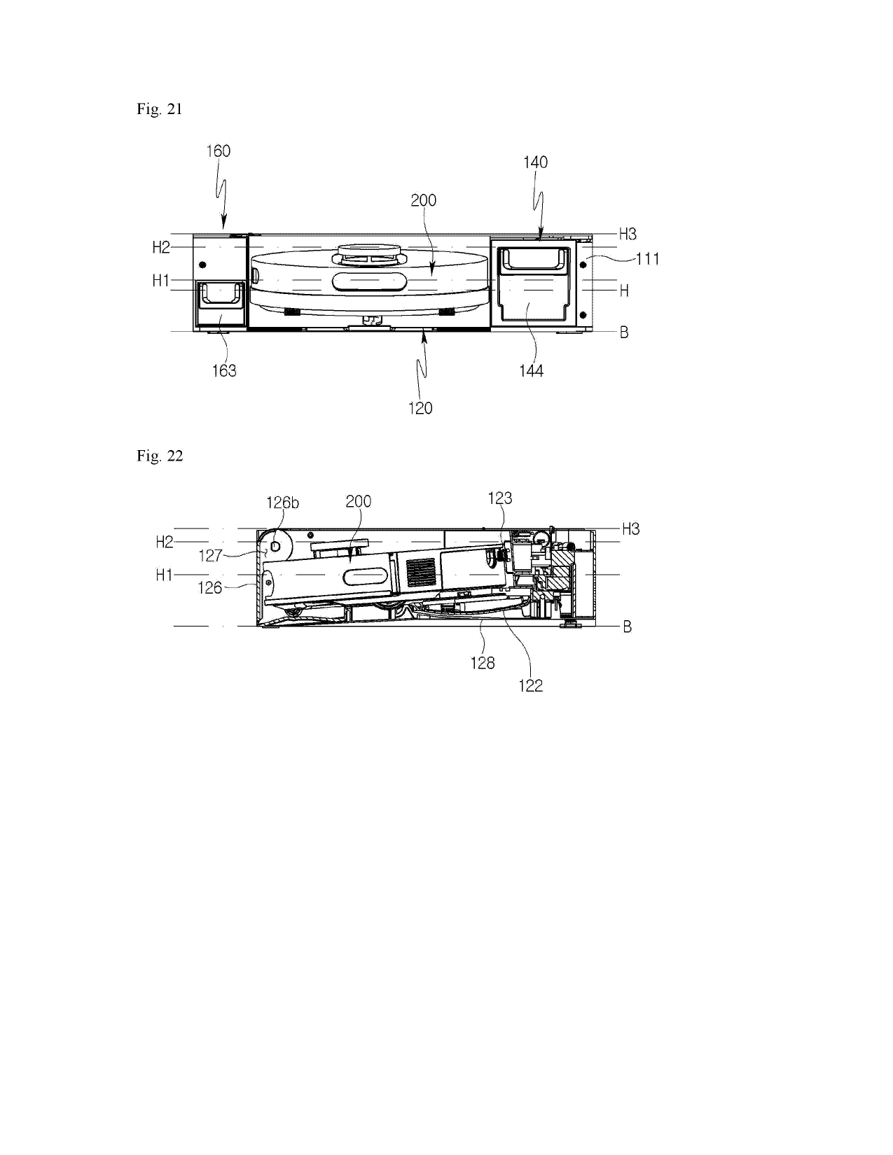

FIGS. 21 and 22 are views to describe the arrangement relationship on a horizontal side of the robot cleaner station according to embodiments of the present disclosure.

Referring to FIGS. 4, 21, and 22, the arrangement of the robot cleaner station 100 according to an embodiment of the present disclosure will be described as follows.

The robot cleaner station 100 according to an embodiment of the present disclosure is characterized by being installed in the lower space of a kitchen cabinet 2.

To this end, the robot cleaner station 100 according to an embodiment of the present disclosure is characterized by being arranged horizontally to fit the space formed between the lower plate 23 of the kitchen cabinet 2 and the kitchen floor.

Specifically, the robot cleaner station 100 according to an embodiment of the present disclosure may have the dust collection unit 140 and/or the mop washing unit 160 arranged on the side of the entrance 127.

At this time, if both the dust collection unit 140 and the mop washing unit 160 are provided, the mounting unit 120 may be placed between the dust collection unit 140 and the mop washing unit 160.

For example, the entrance 127 and the door 126 may be placed in front of the robot cleaner station 100. Furthermore, the mounting unit 120 to which the robot cleaner 200 is coupled may be placed rearward from the entrance 127. At this time, the dust collection unit 140 may be placed a predetermined distance from the front end of the robot cleaner station 100 to the rear. Furthermore, the mop washing unit 160 may also be placed a predetermined distance from the front end of the robot cleaner station 100 to the rear.

Therefore, when looking at the robot cleaner station 100 from the front outside of the robot cleaner station 100, the front end of the dust collection unit 140 and/or the front end of the mop washing unit 160 may be arranged on the left and right of the entrance 127.

At this time, the dust bag (not shown) of the dust collection unit 140 may be provided so as to be withdrawable to the front of the housing 110. In addition, the detergent container 163 of the mop washing unit 160 may be provided so as to be withdrawable to the front of the housing.

That is, the handle 144d may be provided at the front end of the dust collection unit 140 so as to enable a user to hold the dust collection unit housing 141. In addition, the handle 163b may be provided at the front end of the mop washing unit 160 to enable the detergent container 163 to be pulled out.

With this configuration, when a user wants to pull out the dust bag (not shown) or detergent container 163, the pull-out position may be immediately recognized, and the user may conveniently pull out the dust bag (not shown) or detergent container 163 with just a simple action of pulling the handle.

Meanwhile, the rear end of the dust collection unit housing 141 and the detergent container 163 may be arranged at a predetermined distance from the rear end of the housing 110. In addition, the dust collection motor 145 may be arranged between the rear end of the dust collection unit housing 141 and the rear end of the housing 110. With this configuration, the connection of a power line supplying power to the dust collection motor 145 may be facilitated. In addition, there is an effect of minimizing the overall space occupied by the mounting unit 120, the dust collection unit housing 141, and the dust collection motor 145 within a limited space.

In addition, at least a flow path for the wash water for washing the mop 242 and a pump providing the flow force of the wash water may be arranged between the rear end of the housing 110 and the rear end of the detergent container 163. With this configuration, the path for wash water to flow from the water supply pipe can be minimized. Furthermore, the overall space occupied by the mounting unit 120, the mop detergent container 163, and the flow path for wash water can be minimized within a limited space.

Meanwhile, the robot cleaner station 100 may have the mop drying unit 170 positioned rearward of the mounting unit 120. At this time, the mop drying unit 170 may be positioned between the rear end of the mounting unit 120 and the rear end of the housing 110.

Therefore, the robot cleaner station 100 according to an embodiment of the present disclosure may have the dust collection unit 140 and the mop washing unit 160 positioned on the left and right sides of the mounting unit 120, and the mop drying unit 170 positioned rearward.

That is, the robot cleaner station 100 according to an embodiment of the present disclosure may have the dust collection unit 140, the mop washing unit 160, and the mop drying unit 170 all positioned within a predetermined distance from the outer edge of the mounting unit 120.

This arrangement allows the mounting unit 120, dust collection unit 140, mop washing unit 160, and mop drying unit 170 to all be placed in the narrowest space on the horizontal plane.

This shortens the distance between the dust bin 220 and the dust collection unit 140 of the robot cleaner 200, thereby minimizing flow loss. Furthermore, by minimizing the distance between the mop 242 and the mop washing unit 160 of the robot cleaner 200, and between the mop 242 and the mop drying unit 170 of the robot cleaner 200, it is possible to limit the range of wash water and washed wastewater.

Furthermore, this arrangement allows the robot cleaner station 100 of the present disclosure to place all components within a limited height.

Specifically, based on the state in which the robot cleaner 200 is coupled to the mounting unit 120, at least a portion of the dust collection unit 140 may be positioned lower than the uppermost portion of the robot cleaner 200. Furthermore, at least a portion of the mop washing unit 160 may be positioned lower than the uppermost portion of the robot cleaner 200. Furthermore, at least a portion of the mop drying unit 170 may be positioned lower than the uppermost portion of the robot cleaner 200.

Furthermore, based on the state in which the robot cleaner 200 is coupled to the mounting unit 120, the uppermost portion of the robot cleaner 200 may be positioned higher than the dust bag drawer 144. Furthermore, the uppermost portion of the robot cleaner 200 may be positioned higher than the detergent container 163. In addition, the top of the dust bag drawer 144 may be positioned higher than the detergent container 163.

Consequently, the robot cleaner station 100 according to the embodiment of the present disclosure may have the dust collection unit 140, the mop washing unit 160, and the mop drying unit 170 positioned on three sides surrounding the mounting unit 120 except for the front side where the robot cleaner 200 enters. By this arrangement, even in a situation where the vertical height is limited, it is possible to charge the robot cleaner 200 using a minimum of horizontal space, as well as collect dust from the robot cleaner 200, wash the mop 242, and dry the mop 242.

### Drawer:

If the charging stand for the robot cleaner is placed under a kitchen cabinet, it may provide an interior effect by minimizing exposure to the outside, but there is a limitation that if the robot cleaner breaks down while it is placed under the kitchen cabinet or if the charging stand for the robot cleaner breaks down, it may be difficult for the user to take it out and repair it. To solve this problem, in the present invention, a drawer 190 may be added to the robot cleaner station 100.

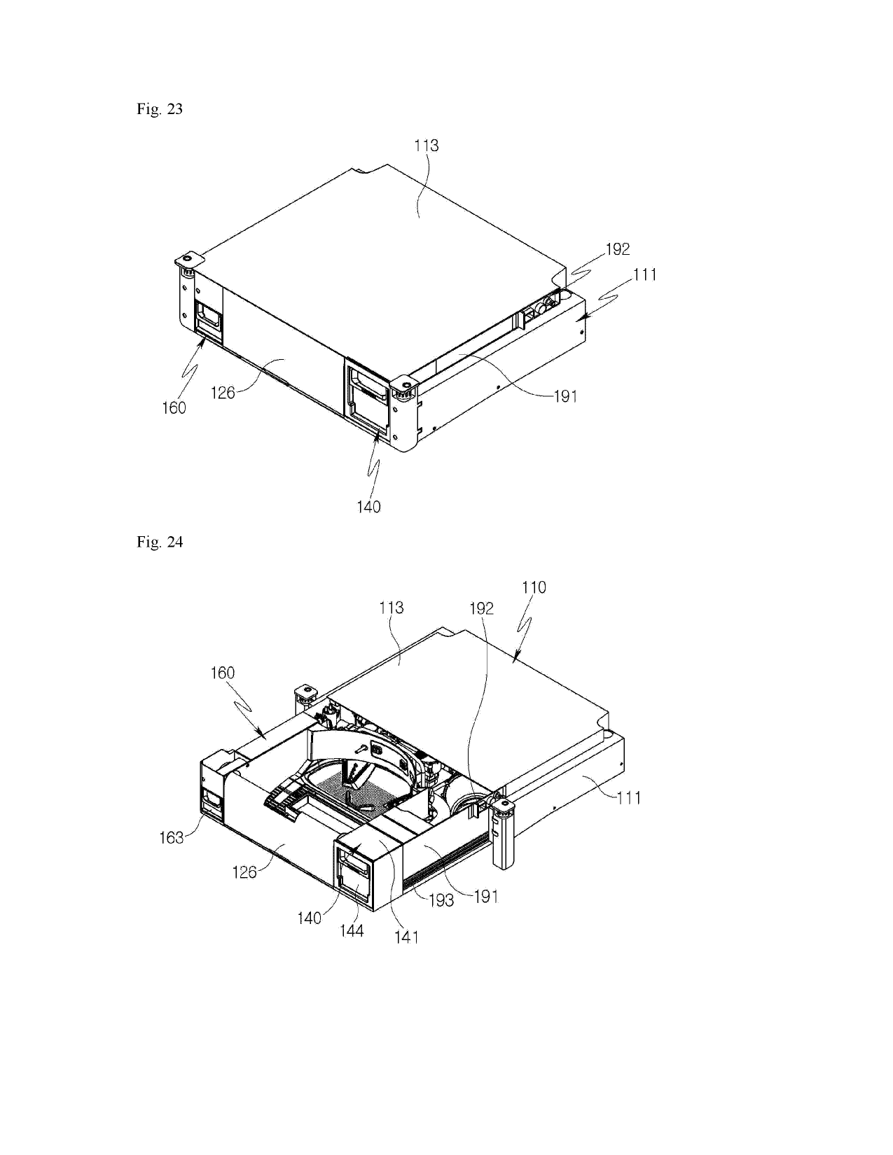

In this regard, FIG. 23 is a view showing a state in which a drawer is provided in a robot cleaner station according to an embodiment of the present invention. FIG. 24 is a view showing a state in which a drawer is withdrawn in a robot cleaner station according to an embodiment of the present disclosure;

Referring to FIGS. 23 and 24, the drawer 190 of the robot cleaner station 100 according to one embodiment of the present invention will be described as follows.

The robot cleaner station 100 according to one embodiment of the present disclosure may further include the drawer (190) that is drawn out from the housing 110.

When the drawer 190 is inserted into the housing 110, the door 126 may be closed when the robot cleaner 200 enters the mounting unit 120. In this case, the inside and outside of the housing 110 of the robot cleaner 200 may be blocked by the door 126.

As a result, the robot cleaner 200 may prevent dust from flying out of the robot cleaner station 100 while collecting dust from the dust bin 220 inside the housing 110. In addition, it can prevent wastewater from leaking out of the robot cleaner station 100 while the mop 242 is being washed.

The drawer 190 may be moved relative to the housing 110. For example, the housing 110 may be fixedly connected to the kitchen cabinet 2, and the drawer 190 may be pulled out forward from the housing 110.

At this time, the drawer 190 may be pulled out while having a mounting unit 120 provided therein. With this configuration, when the drawer 190 is pulled out, the mounting unit 120 and/or the robot cleaner 200 may be pulled out from the kitchen cabinet 2.

At this time, when the drawer 190 is pulled out from the housing 110 while the door 126 closes the entrance 127, the robot cleaner 200 placed in the mounting unit 120 may be exposed to the outside.

Therefore, according to the present embodiment, when maintenance such as repair or cleaning of the robot cleaner station 100 is required, the user can easily pull out the mounting unit 120 and/or the robot cleaner 200 through the drawer 190 to expose the internal components of the robot cleaner station 100 or the robot cleaner 200.

Meanwhile, the drawer 190 according to one embodiment of the present disclosure may be withdrawn with the dust collection unit 140 provided therein. That is, the drawer 190 may be withdrawn together with the dust collection unit 140.

On the other hand, the dust collection unit 140 of the present disclosure may be withdrawn from the housing 110 separately from the drawer 190. At this time, the direction in which the dust collection unit 140 is withdrawn can be parallel to the direction in which the drawer 190 is withdrawn. For example, the direction in which the dust bag drawer 144 is withdrawn can be parallel to the direction in which the drawer 190 is withdrawn.

In addition, the drawer 190 according to one embodiment of the present disclosure may be withdrawn with at least a portion of the mop washing unit 160 provided therein. That is, the drawer 190 may be withdrawn together with at least a portion of the mop washing unit 160. For example, the drawer 190 may be withdrawn together with the detergent container 163 and the waste container 164d.

On the other hand, the detergent container 163 of the present disclosure may be withdrawn from the housing 110 separately from the drawer 190. At this time, the direction in which the detergent container 163 is withdrawn can be parallel to the direction in which the drawer 190 is withdrawn.

With this configuration, the robot cleaner station 100 according to one embodiment of the present disclosure may be provided with the drawer 190, the dust collection unit 140, and the detergent container 163 all having parallel withdrawal directions.

Therefore, the user can easily recognize the withdrawal directions of the components of the robot cleaner station 100 of the present disclosure, and may easily withdraw them for repair and maintenance.

The drawer 190 includes a drawer side wall 191, a fitting portion 192, and a drawer rail 193.

The drawer side wall 191 is provided to be relatively movable with respect to the outer wall surface of the housing 110. For example, a pair of drawer side walls 191 may be arranged to face the outer wall surfaces of the pair of housings 110.

In this case, the pair of drawer side walls 191 may be arranged closer to the inner side of the robot cleaner station 100 than the outer wall surfaces of the pair of housings 110. That is, the pair of drawer side walls 191 may be arranged closer to the mounting unit 120 than the outer wall surfaces of the pair of housings 110.

At this time, the pair of drawer side walls 191 may be directly connected to the base 121 of the mounting unit 120. Alternatively, the pair of drawer side walls 191 may be connected by the drawer base (not shown), and the mounting unit 120 may be coupled to the upper side of the drawer base (not shown) and may move together.

Meanwhile, a dust collection unit 140 and/or the mop washing unit 160 may be arranged between the drawer side walls 191 and the mounting unit 120. That is, based on the state in which the robot cleaner 200 is coupled to the mounting unit 120, the dust collection unit 140 and/or the mop washing unit 160 may be arranged between the robot cleaner 200 and the drawer side walls 191.

With this configuration, the dust collection unit 140 and the mop washing unit 160 may be positioned using minimal horizontal space.

The fitting portion 192 is provided on the drawer side wall 191 and is detachably connected to at least one of a hose and a power line. For example, the fitting portion 192 may be positioned on the drawer side wall 191 and may be connected to a hose and/or a power line.

The fitting portion 192 is attached to the drawer side wall 191, with one side of the fitting portion 192 positioned in the inner space of the drawer 190 relative to the drawer side wall 191, and the other side of the fitting portion 192 positioned outside the drawer side wall 191.

The fitting portion 192 is detachably connected to at least one of a hose and a power line. For example, the fitting portion 192 may be detachably connected to at least one of the water supply pipe connecting portion to which a water supply pipe is connected, the drain pipe connecting portion to which the drain pipe is connected, the exhaust pipe connecting portion to which a steam exhaust pipe for discharging air inside the drawer 190 is connected, and a power connecting portion to which a power source is connected.

At this time, the water supply pipe of the mop washing unit 160 and the water supply pipe connected from an external water source may be connected to both sides of the water supply pipe connection part, respectively. In addition, the drain pipe of the mop washing unit 160 and the drain pipe connected to the upstream 25b of the utensil trap of the kitchen cabinet 2 may be connected to both sides of the drain pipe connection part, respectively.

That is, the fitting portion 192 of the present disclosure may be structured to detachably connect the water supply and drain pipes for direct drainage using the water source and drain pipes provided in the kitchen cabinet 2 with the water supply and drain pipes inside the robot cleaner station 100.

Additionally, air exhaust pipes connected from an air discharge hole 172b of the mop drying unit 170 may be connected to both sides of the exhaust pipe connection.

Accordingly, air discharged from the mop drying unit 170 may be exhausted to the downstream side 25c of the u-trap.

Furthermore, the power connection unit may be connected to a power line to connect an external power source. The power line may be connected directly to the power connection unit, or may be connected using a power line connection means such as a connector or adapter.

The drawer rail 193 is arranged on the drawer side wall 191 and may guide the movement of the drawer side wall 191. The drawer rail 193 is fixedly connected to the drawer side wall 191 or is formed integrally with the drawer side wall 191, and may be connected to a rail installed on the outer wall 111 of the housing 110 to guide the movement path of the drawer side wall 191. Meanwhile, although the present invention describes that the drawer 190 and the housing 110 are provided with rails, it is not necessarily limited to the form of a rail, and may include all forms such as rollers, guide grooves, or guide ribs that may replace the rails.

### Control configuration:

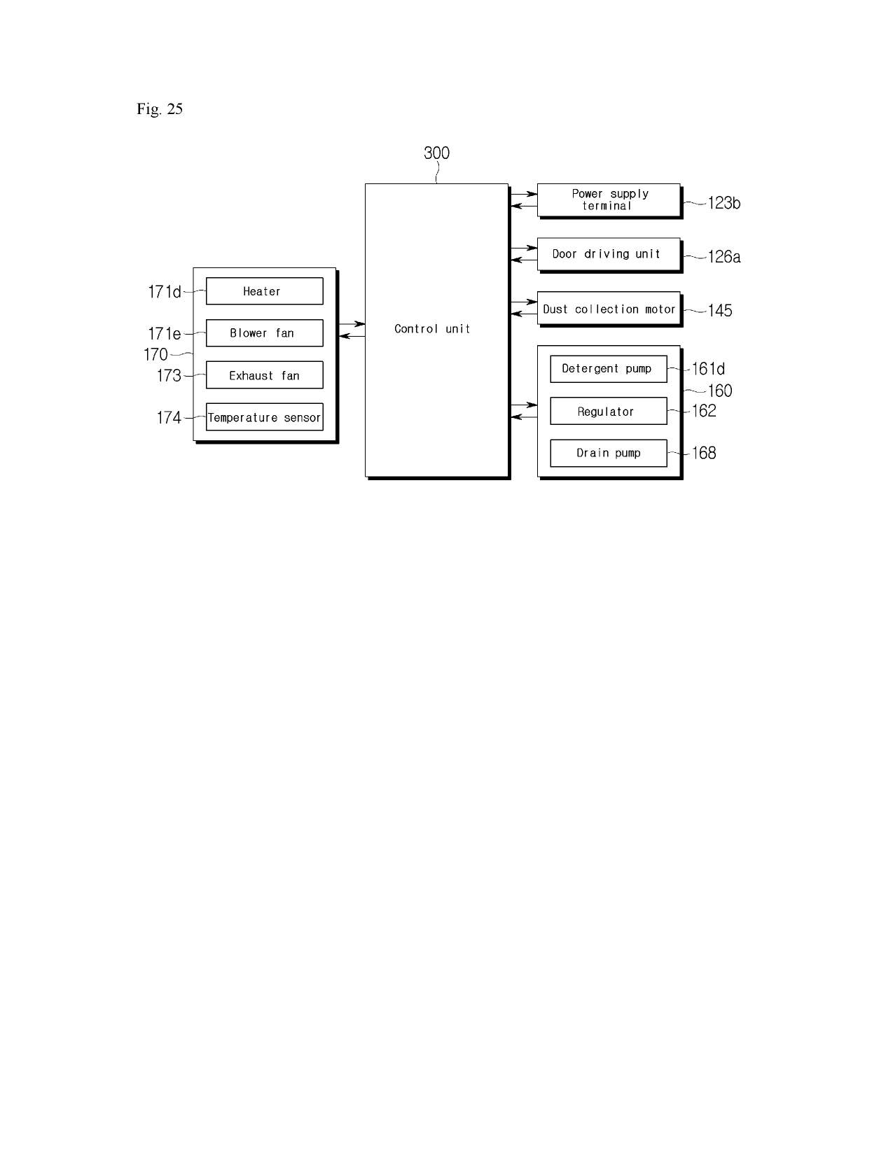

FIG. 25 is a block view showing a control configuration in a robot cleaner station according to an embodiment of the present disclosure.

Referring to FIG. 25, the control configuration of the robot cleaner station 100 of the present disclosure will be described as follows.

The cleaner station 100 according to an embodiment of the present disclosure further includes a control unit 300 that controls a mounting unit 120, a dust collection motor 145, a mop washing unit 160, and a mop drying unit 170.

The control unit 300 may be composed of a printed circuit board and components mounted on the printed circuit board.

The control unit 300 may detect the approach of the robot cleaner 200 and control the door driving unit 126a to rotate the door 126. Specifically, if the distance between the robot cleaner 200 and the door 126 is closer than a preset distance, the control unit 300 may rotate the door 126 to open the entrance 127. Furthermore, if the robot cleaner 200 is coupled to the mounting unit 120, the control unit 300 may rotate the door 126 to close the entrance 127.

When power is supplied to the battery of the robot cleaner 200 from the power supply terminal 123b, the control unit 300 may determine that the robot cleaner 200 is coupled to the mounting unit 120.

The control unit 300 may drive the dust collection motor 145 to suck up dust inside the dust bin 220 of the robot cleaner 200.

Meanwhile, the robot cleaner station 100 according to an embodiment of the present disclosure may include a memory (not shown). The memory may contain various data for driving and operating the robot cleaner station 100.

Meanwhile, the robot cleaner station 100 according to an embodiment of the present disclosure may include a communication unit (not shown). The communication unit may support wireless communication with other devices outside the robot cleaner station 100, including the robot cleaner 200 or a terminal (not shown). A short-range communication module or a long-range communication module may be provided as a wireless communication module to support wireless communication.

Short-range communication may be, for example, Bluetooth communication or NFC (Near Field Communication).

Long-distance communication includes, for example, Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSUPA), High Speed Uplink Packet Access (HSUPA), IEEE 802.16, Long Term Evolution (LTE), Long Term Evolution-Advanced (LTEA), Wireless Mobile Broadband Service (WMBS), Bluetooth Low Energy (BLE), Zigbee, and Radio Frequency (RF). It could be LoRa (Long Range), etc.

The control unit 300 may control the mop washing unit 160.

Specifically, the control unit 300 may control the detergent pump 161d. The control unit 300 can operate the detergent pump 161d to discharge detergent stored in the detergent container 163 to the mop 242.

Furthermore, the control unit 300 may control the regulator 162. The control unit 300 may operate the regulator 162 to adjust the amount of purified water discharged to the mop 242.

Furthermore, the control unit 300 may control the drain pump 168. The control unit 300 may operate the drain pump 168 to drain wastewater after washing the mop 242.

The control unit 300 may control the mop drying unit 170.

Specifically, the control unit 300 may control the heater 171d. The control unit 300 may operate the heater 171d to heat the air discharged to the mop 242.

Furthermore, the control unit 300 may control the blower fan 171e. The control unit 300 may operate the blower fan 171e to discharge air to the mop 242.

Furthermore, the control unit 300 may control the exhaust fan 173. The control unit 300 may operate the exhaust fan 173 to discharge air after drying the mop 242 to the outside.

In addition, the control unit 300 may receive a signal from the temperature sensor 174. The control unit 300 may measure the temperature of the air within the housing 110 through the temperature information received from the temperature sensor 174. In addition, the control unit 300 may control the operation of the heater 171d based on the temperature information received from the temperature sensor 174 to sterilize bacteria present in the mop 242.

Water supply and drainage connection pipe rotating module structure:

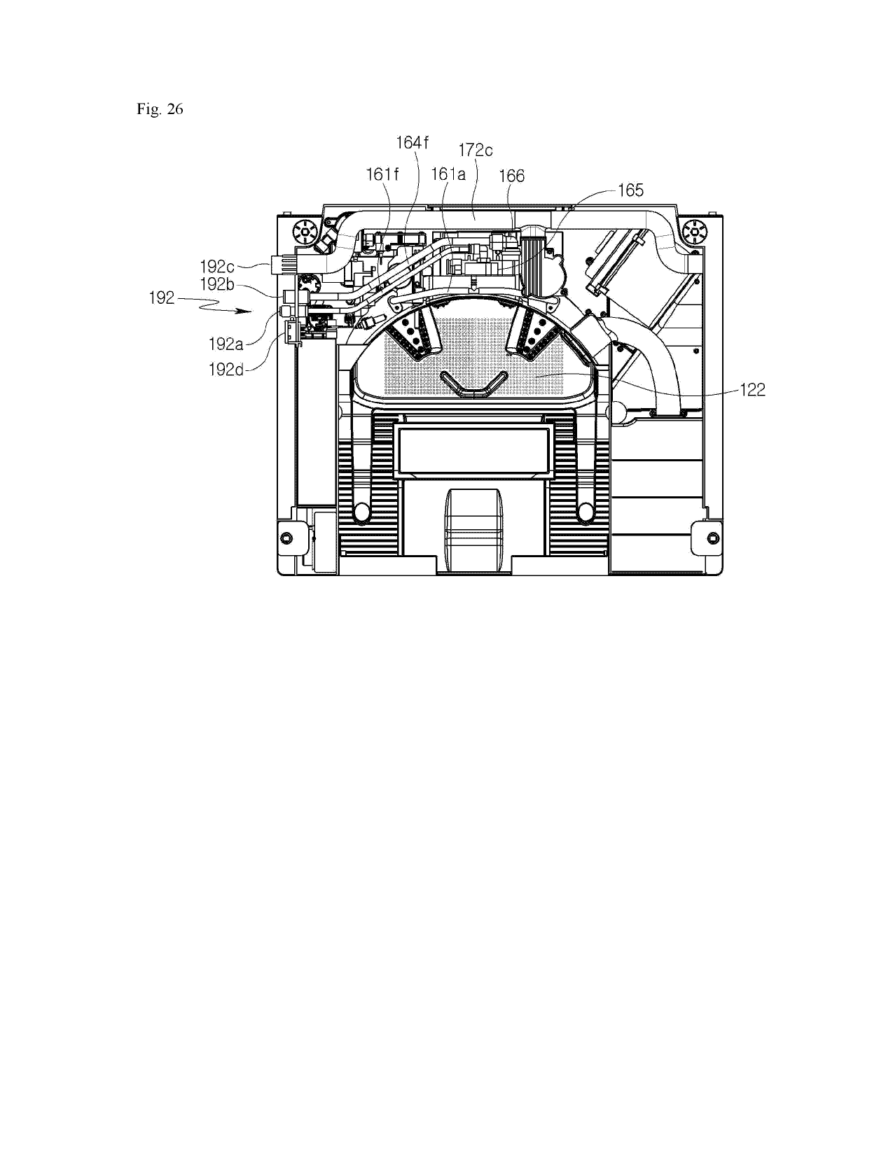

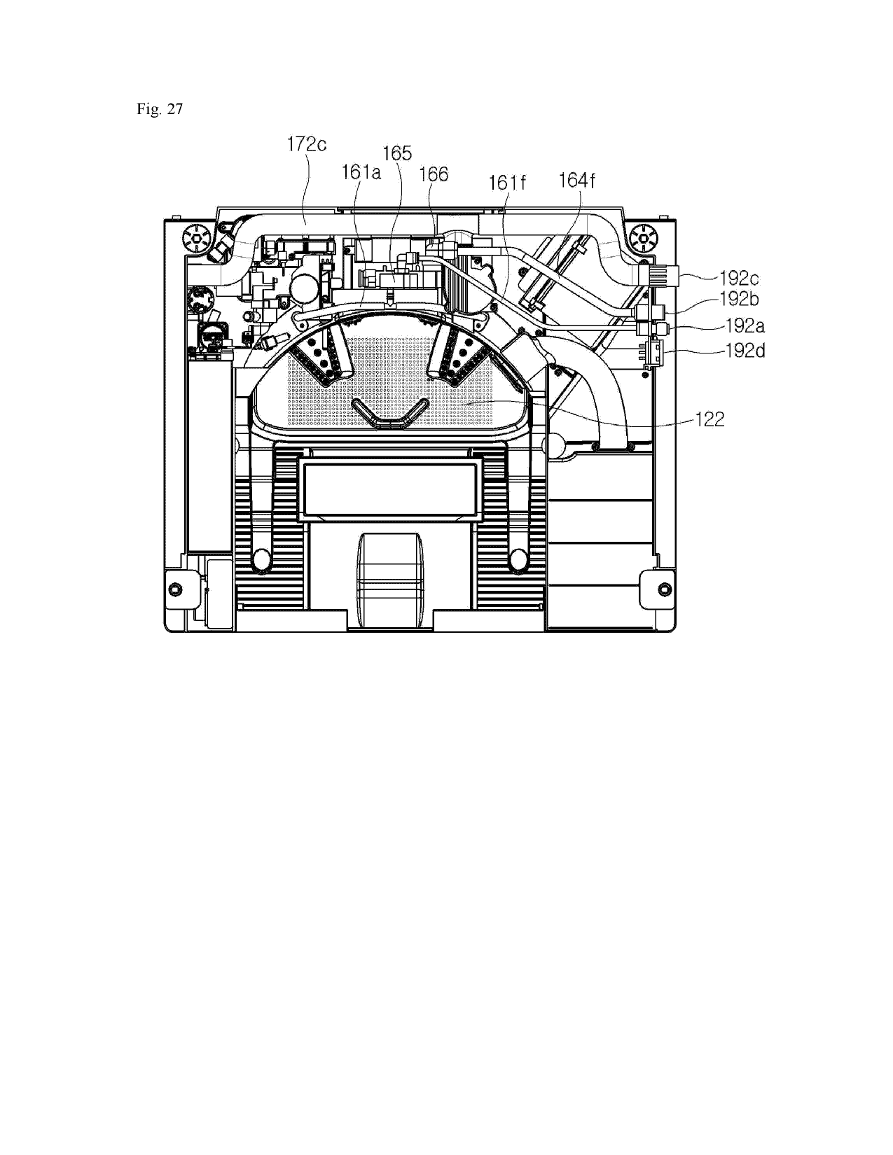

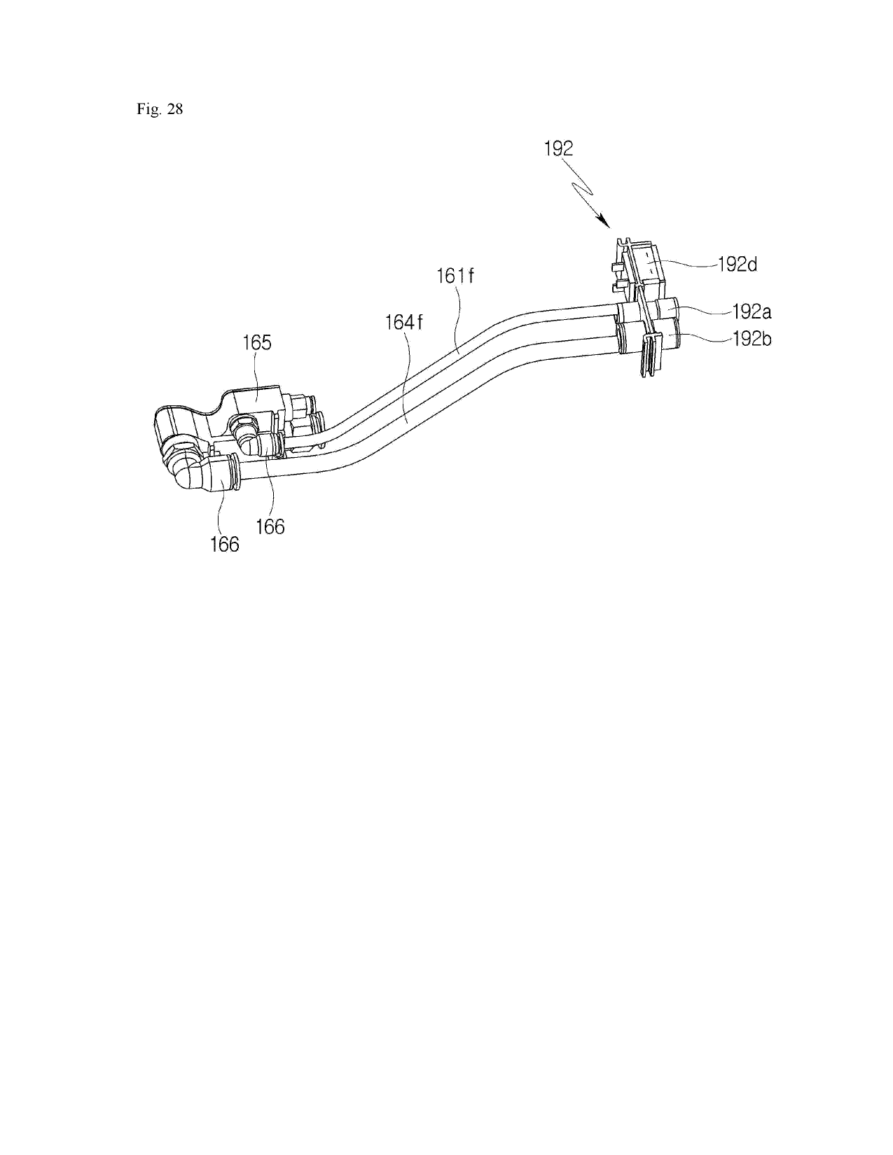

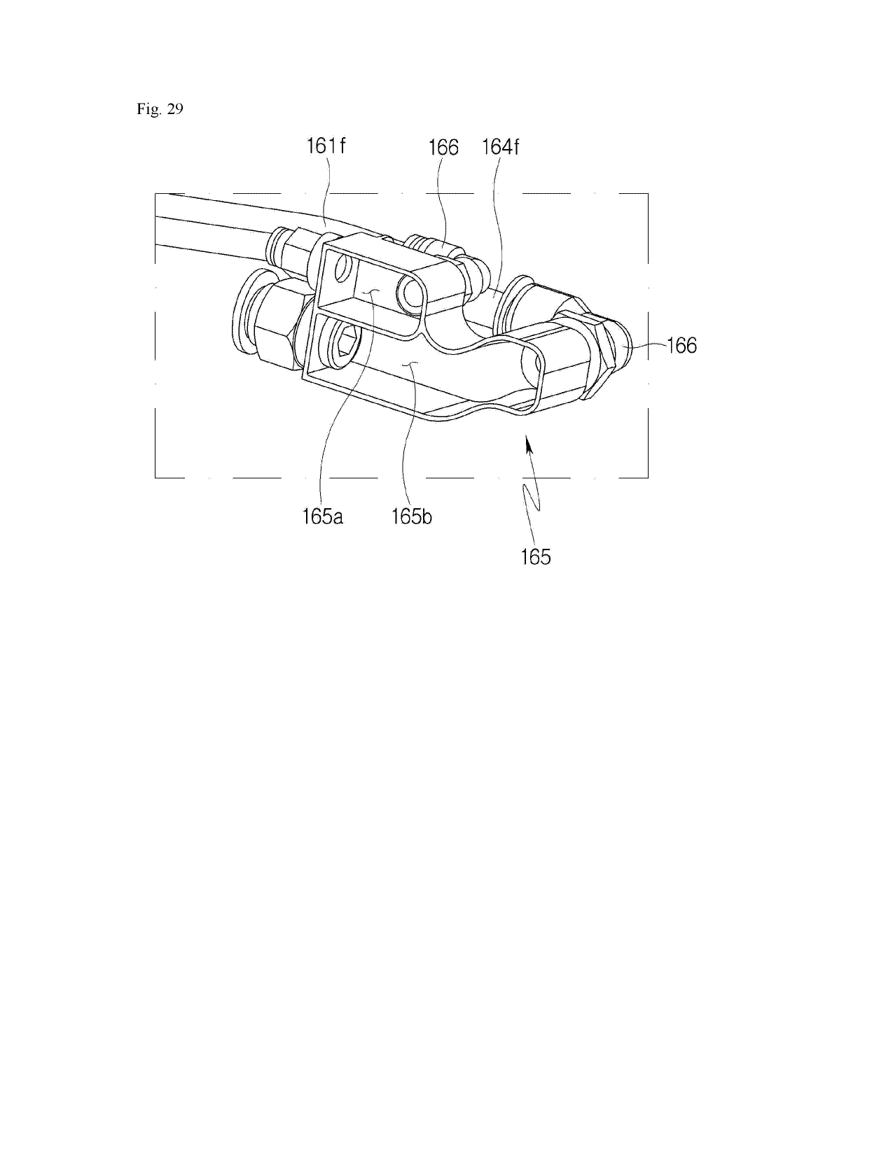

FIG. 26 is a view showing a state in which a water supply connection pipe and a drain connection pipe are connected to a fitting portion disclosed on the right outer wall in a robot cleaner station according to an embodiment of the present disclosure. FIG. 27 is a view showing a state in which a water supply connection pipe and a drain connection pipe are connected to a fitting positioned on the left outer wall in a robot cleaner station according to an embodiment of the present disclosure. FIG. 28 is a view showing a flow path connection module in a robot cleaner station according to an embodiment of the present disclosure. FIG. 29 is a cross-sectional view showing the internal space of a flow path connection module in a robot cleaner station according to an embodiment of the present disclosure.

Referring to FIGS. 26 to 29, the mop washing unit 160 of the robot cleaner station 100 according to another embodiment of the present disclosure will be described as follows.

The mop washing unit 160 is disposed in the housing 110 and can wash the mop 242 of the robot cleaner 200 coupled to the mounting unit 120.

The mop washing unit 160 may include a washing water supply unit 161 that discharges water introduced from an external water source to the washing plate 122, and a wastewater discharge unit 164 that discharges the washing water from the mop 242 after it has been washed.

First, the washing water supply unit 161 may include a washing water nozzle (not shown), a branch flow path 161a, a regulator 162, and a water supply connection pipe 161f.

The washing water nozzle (not shown) may discharge water for washing the mop 242 of the robot cleaner 200. That is, washing water may be sprayed onto the mop 242 of the robot cleaner 200 through the washing water nozzle (not shown), thereby performing the washing operation of the mop 242. The washing water nozzles (not shown) may be arranged in pairs spaced apart from each other on the rear side of the coupling wall 123. The washing water nozzles 161b may discharge washing water toward the washing plate 122 from the upper sides of both ends of the washing plate 122.

At this time, purified water supplied from the water supply pipe of the kitchen cabinet 2 may flow to the regulator 162 through the water supply connection pipe 161f and the flow path connection module 165 described later. The water flowing to the regulator 162 may be branched to both sides through the branch flow path 161a and connected to each of the spaced-apart washing water nozzles (not shown). That is, the branch flow path 161a can be formed in the form of one pipe branching into two. The branch flow path 161a may include a T-shaped connector. One end of the connector can be connected to one of a pair of washing water nozzles (not shown), and the other end can be connected to the other of a pair of washing water nozzles (not shown).

The water supply connection pipe 161f may supply water flowing in from an external water source to the flow path connection module 165 described later. Water may be supplied to the first space 165a of the flow connection module 165 through the water supply connection pipe 161f. In addition, the water supply connection pipe 161f is disposed within the housing 110 and may supply fluid from an external water source to the washing plate 122.

The water supply connection pipe 161f may be pivotally coupled to the flow connection module 165. More specifically, the water supply connection pipe 161f may be connected to an elbow fitting 166 pivotally coupled to the flow connection module 165. One end of the water supply connection pipe 161f may be connected to the flow connection module 165 or the elbow fitting 166, and the other end can be connected to the fitting portion 192 disposed on the outer wall 111 of the robot cleaner station 100.

The other end of the water supply connection pipe 161f may be selectively connected to the left outer wall 111c or the right outer wall 111d. That is, the water supply connection pipe 191f may be detachably connected to either one of a pair of fitting portions 192. If the drain pipe 25 of the kitchen cabinet 2 is located on the left side of the robot cleaner station 100, the other end of the water supply connection pipe 161f may be connected to the fitting portion 192 arranged on the left outer wall 111c. Alternatively, if the drain pipe 25 of the kitchen cabinet 2 is located on the right side of the robot cleaner station 100, the other end of the water supply connection pipe 161f may be connected to the fitting portion 192 arranged on the right outer wall 111d.

In summary, water supplied from the water supply pipe of the kitchen cabinet 2 may pass through the outer wall 111 of the robot cleaner station 100 and flow into the water supply connection pipe 161f. At this time, the outer wall 111 may be the left outer wall 111c or the right outer wall 111d of the housing 110. Water moving through the water supply connection pipe 161f may flow into the flow path connection module 165. Water passing through the flow path connection module 165 may flow to the regulator 162. Water flowing to the regulator 162 may be discharged through the washing water nozzle (not shown) along the branch flow path 161a.

That is, water for washing the mop 242 may be discharged through the water supply pipe of the kitchen cabinet 2, the water supply connection pipe 161f, the flow path connection module 165, the regulator 162, and the branch flow path 161a in that order, and then through the washing water nozzle (not shown). The discharged water can fall on the washing plate 122 or the upper surface of the mop 242.

The wastewater discharge unit 164 may include a wastewater inlet 164c, a wastewater tank 164d, and a drain connection pipe 16f.

Water used for washing the mop 242 may be sucked in through the wastewater inlet 164c. The wastewater inlet 164c may be configured to protrude from the wall of the washing tank 128. In addition, the open portion of the wastewater inlet 164c may be arranged to face the bottom of the washing tank 128. Liquid passing through the washing plate 122 accumulates in the washing tank 128, and the liquid accumulated in the washing tank 128 may be discharged to the outside through the wastewater inlet 164c. Water discharged through the wastewater inlet 164c may flow into the wastewater tank 164d. Water flowing into the wastewater tank 164d may flow back to the flow path connection module 165. The water flowing into the wastewater tank 164d may flow into the second space 165b of the flow path connection module 165.

The drain connection pipe 164f allows water discharged from the flow path connection module 165 to pass through it. The drain connection pipe 164f may discharge water flowing into the flow path connection module 165 to the outside. The drain connection pipe 164f may discharge water within the second space 165b of the flow path connection module 165 to the outside. Furthermore, the drain connection pipe 164f is disposed within the housing and can discharge fluid passing through the washing plate 122.

The drain connection pipe 164f may be pivotally coupled to the flow path connection module 165. More specifically, the drain connection pipe 164f may be connected to an elbow fitting 166 pivotally coupled to the flow connection module 165. One end of the drain connection pipe 164f may be connected to the flow connection module 165 or the elbow fitting 166, and the other end can be connected to the fitting portion 192 disposed on the outer wall 111 of the robot cleaner station. More specifically, the other end of the drain connection pipe 164f may be connected to a drain connection pipe coupling portion 192b of the fitting portion 192.

In summary, water used to wash the mop 242 may pass through the washing plate 122 and accumulate in the washing tank 128. The water accumulated in the washing tank 128 may be sucked through the wastewater inlet 164c and flow into the wastewater tank 164d. Water flowing into the wastewater tank 164d may flow back into the flow connection module 165. Water flowing into the flow connection module 165 may be discharged through the drain connection pipe 164f. Water passing through the drain connection pipe 164f may flow through the outer wall 111 of the robot cleaner station 100 to the wastewater discharge path 164a.

At this time, the outer wall 111 may be the left outer wall 111c or the right outer wall 111d of the housing 110. That is, the drain connection pipe 164f may be detachably attached to either one of the pair of fitting portions 192.

That is, the water used to wash the mop 242 may sequentially pass through the wastewater inlet 164c, the wastewater tank 164d, the drain connection module 165, the drain connection pipe 164f, and the wastewater discharge path 164a and then be discharged to the outside through the drain pipe 25 of the kitchen cabinet 2. Through this, the water used to wash the mop 242 may be discharged to the outside of the robot cleaner station 100.

Meanwhile, the diameter of the drain connection pipe 164f may be larger than the diameter of the water supply connection pipe 161f. The water flowing inside the water supply connection pipe 161f may be connected to the drain pipe 25 of the kitchen cabinet 2 and may have a relatively high water pressure. On the other hand, the water flowing through the drain connection pipe 164f may have a relatively low water pressure. To maintain a smooth flow of water during the discharge process, the diameter of the drainage connection pipe 164f may be designed to be larger than that of the water supply connection pipe 161f. This allows the drainage connection pipe 164f to discharge water without blockage even under low water pressure, thereby improving discharge efficiency.

Meanwhile, existing robot cleaner stations used a water tank to wash mops. However, the water tank could only store a certain amount of water, resulting in the inconvenience of having to refill it periodically. To address this issue, the present invention can adopt a direct water connection, directly connected to the kitchen drain pipe 25.

Furthermore, the robot cleaner station 100 of the present disclosure differs from existing direct water connection robot cleaner stations in that it is installed under the kitchen cabinet 2. When installing the robot cleaner station, the operator may encounter space constraints when connecting or disconnecting pipes or hoses.

In the present disclosure, the drain and water supply pipes may be selectively positioned on the left or right side of the robot cleaner station 100, allowing the operator to install the water supply and drain pipes in a suitable direction depending on the installation environment. This possibility of changing direction allows for flexible installation even in confined spaces, thereby improving the installation efficiency of the robot cleaner station 100. Additionally, the fitting portion 192 may be withdrawn together with the drawer 190, allowing the operator to withdraw and place the fitting portion 192 connecting the pipe or hose to a position within arm's reach.

In this regard, the mop washing unit 160 of the robot cleaner station 100 according to an embodiment of the present disclosure may further include a flow path connection module 165 and an elbow fitting 166.

Water supplied to the washing water nozzle (not shown) and water sucked into the wastewater inlet 164c may each pass through the flow path connection module 165. The flow path connection module 165 may have a hollow structure and include a pair of facing surfaces. The pair of facing surfaces of the flow path connection module 165 may be arranged perpendicular to the ground. The internal space of the flow path connection module 165 may be configured to allow fluid to pass through. The width in the left-right direction of the flow path connection module 165 may be formed so that the lower portion is larger than the upper portion.

The flow path connection module 165 may have a shape in which the interior is divided into two spaces. The flow path connection module 165 may include a partition wall horizontal to the ground therein. Through this, the interior space of the flow path connection module 165 may be divided vertically. The flow path connection module 165 may be divided into a first space 165a and a second space 165b. The first space 165a may be positioned above the second space 165b. Water supplied to a wash water nozzle (not shown) may pass through the first space 165a. The second space 165b is divided from the first space 165a, and water sucked into the wastewater inlet 164c may pass through the second space 165b. The left-right width of the second space 165b may be greater than the left-right width of the first space 165a. That is, the second space 165b may be greater than the first space 165a.

Since the washing water nozzle (not shown) discharges water from the upper side of the washing plate 122 toward the washing plate 122, the first space 165a through which the water supply passes may be located relatively higher. On the other hand, since the wastewater inlet 164c is located lower, closer to the bottom of the washing tank 128, the second space 165b through which the drainage flows may be located relatively lower. In addition, since the water pressure of the drainage is relatively weaker than that of the water supply, the second space 165b may have a larger space than the first space 165a to ensure smooth discharge of the water.

The flow path connection module 165 may be formed with inlet holes and discharge holes. At least one inlet hole may be formed in the first space 165a so that fluid supplied from the outside may flow into the first space 165a. Additionally, at least one discharge hole may be formed in the first space 165a so that fluid flowing into the first space 165a may flow to the outside. Specifically, water passing through the water supply connection pipe 161f may flow into the first space 165a through the inlet hole. Water flowing into the first space 165a may flow into the regulator 162 through the discharge hole.

Additionally, at least one inlet hole and discharge hole may also be formed in the second space 165b. Water flowing into the wastewater tank 164d may flow into the second space 165b through the inlet hole formed in the flow path connection module 165. Water flowing into the second space 165b may flow into the drain connection pipe 164f through the discharge hole.

The flow path connection module 165 may be accommodated within the housing 110. The flow path connection module 165 may be positioned between the coupling wall 123 and the rear surface 111b of the housing 110. The elbow fitting 166 may be pivotally coupled to the rear surface of the flow path connection module 165. Here, the rear surface of the flow connection module 165 may be referred to as the rear surface.

The water supply connection pipe 161f and the drain connection pipe 164f may be pivotally coupled to the rear surface of the flow path connection module 165. The pair of elbow fittings 166 corresponding to respective connection pipes may be coupled to the rear surface of the flow path connection module 165. One elbow fitting 166 may be connected to the water supply connection pipe 161f, and the other elbow fitting 166 may be connected to the drain connection pipe 164f. More specifically, an elbow fitting 166 may be pivotally coupled to the rear surface of the euro connection module 165 about an imaginary axis extending along the front-back direction of the robot cleaner station 100.

The elbow fitting 166 connected to the water supply connection pipe 161f may be positioned at the same location as the inlet formed in the first space 165a. Thus, water flowing through the water supply connection pipe 161f may pass through the elbow fitting 166 to the inlet and flow into the first space 165a.

The elbow fitting 166 connected to the drain connection pipe 164f may be positioned at the same location as the outlet formed in the second space 165b. Thus, water flowing through the second space 165b may pass through the elbow fitting 166 to the outlet and flow into the drain connection pipe 164f.

Typically, when installing a robot cleaner station, the length of the water supply connection pipe 161f, drain connection pipe 164f, and power line (not shown) varies depending on the installation location. If the length is too long, the connection pipes and power line (not shown) may bend or become tangled. This can reduce the water flow rate during drainage or supply, or cause power supply problems.

To address this issue, the robot cleaner station 100 of the present disclosure may include an elbow fitting 166.

The elbow fitting 166 may have a bent shape. Specifically, the elbow fitting 166 may be designed as a tube bent in the shape of an "L". The elbow fitting 166 may change the direction of the fluid within by connecting different configurations at both ends.

Additionally, the elbow fitting 166 may be connected to the rear surface of the flow path connection module 165. The elbow fitting 166 may be pivotally coupled to the rear surface of the flow path connection module 165 around an imaginary axis extending along the forward-backward direction of the robot cleaner station 100. The elbow fitting 166 may be connected to a water supply connection pipe 161f or the drain connection pipe 164f. The elbow fittings 166 may be configured as a pair corresponding to each connection pipe.

One end of the elbow fitting 166 may be pivotally coupled to the flow path connection module 165, and the other end may be arranged to face the left outer wall 111c or the right outer wall 111d of the housing 110. Specifically, the elbow fitting 166 may be pivotally arranged around an imaginary axis extending along the forward-backward direction of the robot cleaner station 100. Accordingly, water can move in a direction perpendicular to the rear surface of the flow connection module 165. The water flow path can be bent along the structure of the elbow fitting 166. Therefore, the water flow path can be switched to face the left outer wall 111c or the right outer wall 111d depending on the pivot rotation of the elbow fitting 166.

When the water supply connection pipe 161f or the drain connection pipe 164f passes through the left outer wall 111c and is connected to the drain pipe 25 of the kitchen cabinet 2, the elbow fitting 166 may be pivotally rotated so that the other end faces the left outer wall 111c. At this time, the distance between the other end of the elbow fitting 166 and the left outer wall 111c may be minimized.

When the water supply connection pipe 161f or the drain connection pipe 164f passes through the right outer wall 111d and is connected to the drain pipe 25 of the kitchen cabinet 2, the elbow fitting 166 may be pivotally rotated so that the other end faces the right outer wall 111d. At this time, the distance between the other end of the elbow fitting 166 and the right outer wall 111d may be minimized.

In summary, as the elbow fitting 166 pivots, the distance between the other end of the elbow fitting 166 and the outer wall may be minimized. This prevents kinking of the drain connection pipe 164f and the water supply connection pipe 161f, and their lengths may also be minimized. Furthermore, the linear distance between the other end of the elbow fitting 166 and the outer wall remains constant, eliminating the need for separate water supply connection pipes 161f and drain connection pipes 164f of different lengths. Furthermore, this minimizes water pressure loss, thereby facilitating smooth water flow.

Meanwhile, the drawer 190 of the robot cleaner station 100 according to one embodiment of the present invention may include a fitting portion 192.

The fitting portion 192 may be arranged on the side of the housing 110. The pair of fittings 192 may be respectively arranged on the left outer wall 111c and the right outer wall 111d of the housing 110. The fittings 192 may be connected to the wash water nozzle 161e and the waste water inlet 164c. More specifically, the wash water nozzle 161e and the waste water inlet 164c may be selectively connected to either one of the pair of fittings 192. Water supplied from the kitchen drain pipe 25 may pass through the fittings 192 located on the side of the housing 110 and be discharged to the washing water nozzle 161e. In addition, water inside the robot cleaner station 100 may be sucked back into the waste water inlet 164c, pass through the fittings 192, and be discharged to the kitchen drain pipe 25. Additionally, at least one of the water supply connection pipe 161f, drain connection pipe 164f, and power line (not shown) to be described later may be detachably connected to the fitting portion 192.

Furthermore, the pair of fitting portions 192 may be arranged on the drawer side walls 191. The pair of drawer side walls 191 may be arranged to face the left outer wall 111c and the right outer wall 111d. When the drawer 190 is coupled to the housing 110, the pair of fitting portions 192 may be arranged on the left outer wall 111c and the right outer wall 111d, respectively. One side of the fitting portions 192 is positioned in the inner space of the drawer 190 relative to the drawer side wall 191, and the other side of the fitting portion 192 is positioned outside the drawer side wall 191. The water supply connection pipe 161f and drain connection pipe 164f may be detachably connected to one side of the fitting portion 192 positioned toward the inside of the drawer 190.

Meanwhile, the pair of fitting portions 192 may be connected to the drawer 190. Accordingly, when the drawer 190 is pulled out from the housing 110, the pair of fitting portions 192 may also be pulled out together. Accordingly, the operator may easily detach the water supply connection pipe 161f, the drain connection pipe 164f, and the power line (not shown) when installing or removing the robot cleaner station 100. That is, when the worker pulls the drawer 190 and the fitting portion 192 is pulled forward, the water supply connection pipe 161f, the drain connection pipe 164f, and the power line (not shown) connected to the fitting portion 192 may be separated. Thereafter, when the worker further pulls the drawer 190, the entire drawer 190 may be completely pulled out from the housing 110.

The water supply connection pipe 161f and the drain connection pipe 164f may be selectively connected to either one of the pair of fitting portions 192.

That is, if the drain pipe 25 of the kitchen cabinet 2 is located on the left side of the robot cleaner station 100, the water supply connection pipe 161f and the drain connection pipe 164f may be connected to the fitting portion 192 disposed on the left outer wall 111c.

Alternatively, if the drain pipe 25 of the kitchen cabinet 2 is located on the right side of the robot cleaner station 100, it may be connected to the fitting portion 192 disposed on the right outer wall 111d of the water supply connection pipe 161f and the drain connection pipe 164f.

Meanwhile, the robot cleaner station 100 according to one embodiment of the present invention may include a power line (not shown).

The power supply terminal 123c may be connected to the robot cleaner 200 to supply power. The power supply terminal 123c may be disposed on the connection wall 123.

The power line (not shown) may supply power from the outside to the power supply terminal 123c. One end of the power line (not shown) may be connected to the power supply terminal 123c, and the other end may be connected to the fitting portion 192 The power line (not shown) may be detachably connected to one of the pair of fitting portions 192.

In addition, the air discharge unit 172 of the robot cleaner station 100 according to one embodiment of the present invention may include an air discharge pipe 172c. The air discharge pipe 172c may branch to the left and right sides and be connected to each of the pair of fitting portions 192. One end of the air discharge pipe 172c is connected to the air suction hole 172a, and the other end may branch to the left and right sides and be detachably connected to each of the pair of fitting portions 192.

The air discharge pipe 172c may further include a T-shaped connector and an extension pipe. One end of the connector 172da may be connected to the air suction hole 172a. The connector 172da may branch the air drawn in from the air suction hole 172a into two paths and guide them to a pair of extension pipes. The pair of extension pipes can be connected to each of the pair of fitting portions 192. The pair of extension pipes may be connected to the air discharge pipe coupling portion 192c of the pair of fitting portions 192.

The pair of fitting portions 192 may include a water supply coupling portion 192a, a drain connection pipe coupling portion 192b, and a power coupling portion 192d. That is, each of the pair of fitting portions 192 may include a water supply coupling portion 192a to which the water supply connection pipe 161f is coupled, a drain connection pipe coupling portion 192b to which the drain connection pipe 164f is coupled, and a power connection portion 192d to which a power line (not shown) is connected. Unlike the elbow fitting 166, the above-described water supply connection pipe coupling portion 192a and drain connection pipe coupling portion 192b may be straight pipes capable of combining different configurations at both ends.

A water supply connection pipe 161f and a water supply pipe connected to an external water source may be connected to both sides of the water supply connection pipe coupling portion 192a. Furthermore, the drain connection pipe 164f and the drain pipe 25 connected to the upstream 25b of the water trap of the kitchen cabinet 2 may be connected to both sides of the drain connection pipe coupling portion 192b. That is, the fitting portion 192 of the present disclosure may be configured to detachably connect the water supply source and drain pipe provided in the kitchen cabinet 2 with the water supply connection pipe 161f and drain connection pipe 164f inside the robot cleaner station 100.

The power coupling portion 192d may be connected to a power line so that an external power source may be coupled. At this time, the power line (not shown) can be directly connected to the power coupling portion 192d, or the power line (not shown) may be connected using a power connection means such as a connector or adapter.

In addition, the pair of fitting portions 192 may further include an air discharge pipe coupling portion 192c. The air discharge pipe 172c and the drain pipe 25 connected to the downstream 25c of the kitchen cabinet 2 may be connected to both sides of the air discharge pipe coupling portion 192c. At this time, the unused air discharge pipe coupling portion 192c may be closed using a plug. The plug may be configured to cover the air discharge pipe coupling portion 192c protruding from the outer wall 111 of the housing 110.

Through this configuration, the robot cleaner station 100 of the present disclosure may selectively set the connection location of the water supply pipe and the drain pipe to either the left or right side of the robot cleaner station 100 when washing the mop 242 of the robot cleaner 200. In addition, the air exhaust path and power line connection location may be selectively set to either the left or right side of the robot cleaner station 100.

This has the effect of maximizing the installation efficiency of the robot cleaner station 100.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention.

Further, although the operating effects according to the configuration of the present invention are not explicitly described while describing an embodiment of the present invention, it should be appreciated that predictable effects are also to be recognized by the configuration.

### Description of Numeral References

1: Cleaner system 2: Kitchen cabinet

100: Robot cleaner station 110: Housing

120: Mounting unit 122: Washing plate

128: Washing tank 140: Dust collection unit

160: Mop washing unit 161: Wastewater supply unit

161f: Water supply connection pipe 164: wastewater discharge portion

165: Flow path connection module 165a: First space

165b: Second space 166: Elbow fitting

170: Mop drying unit 172c: Air discharge pipe

192: Fitting portion 200: Robot cleaner

1. A robot cleaner station comprising:
a housing comprising a pair of outer walls facing each other;
a mop washing unit disposed within the housing and configured to wash a mop of a robot cleaner; and
a fitting portion disposed on a side of the housing,
wherein the mop washing unit comprises:
a wash water nozzle configured to discharge water for washing the mop;
a wastewater inlet configured to suck in water used for washing the mop, and
wherein the fitting portion is configured to be connected to the wash water nozzle and the wastewater inlet.

2. The robot cleaner station of claim 1, wherein the outer wall comprises a left outer wall positioned on the left; and
a right outer wall positioned on the right, when looking forward from inside the robot cleaner station, with the direction in which the robot cleaner is introduced being forward,
the fitting portion is formed on each of the left outer wall and the right outer wall, and
the wash water nozzle and the wastewater inlet are selectively connected to one of the pair of fitting portions.

3. The robot cleaner station of claim 2, further comprising:
a flow path connection module through which water supplied to the wash water nozzle and water sucked into the wastewater inlet pass, respectively;
a water supply connection pipe configured to supply water from an external water source to the flow path connection module; and
a drain connection pipe through which water discharged from the flow path connection module passes;
wherein the water supply connection pipe and the drain connection pipe are configured to be pivotally connected to the flow path connection module.

4. The robot cleaner station of claim 3, wherein the water supply connection pipe and the drain connection pipe are configured to be detachably connected to one of the pair of fitting portions.

5. The robot cleaner station of claim 3, wherein the diameter of the drain connection pipe is larger than the diameter of the water supply connection pipe.

6. The robot cleaner station of claim 3, wherein the mop washing unit comprises:
an elbow fitting having a bent shape and configured to change the direction of internal fluid flow, and
the elbow fitting has one end pivotally connected to the flow path connection module, and the other end positioned so as to face the left or right outer wall of the housing.

7. The robot cleaner station of claim 3, further comprising:
a power supply terminal disposed within the housing and configured to be coupled to the robot cleaner and supply power;
a power line configured to supply power to the power supply terminal from the outside,
wherein the power line is detachably connected to one of the pair of fitting portions.

8. The robot cleaner station of claim 7, wherein each of the pair of fitting portions comprises a water supply connection pipe coupling portion to which the water supply connection pipe is coupled, a drain connection pipe coupling portion to which the drain connection pipe is coupled, and a power connection portion to which the power line is connected.

9. The robot cleaner station of claim 2, further comprising:
a drawer that is drawn out from the housing and comprising a mounting unit on which the robot cleaner is mounted,
wherein the drawer is coupled to the pair of fitting portions.

10. The robot cleaner station of claim 3, wherein the flow path connection module comprises:
a first space through which water supplied to the wash water nozzle passes; and
a second space partitioned from the first space through which water sucked into the wastewater inlet passes, and
the second space is larger than the first space.

11. The robot cleaner station of claim 10, wherein the first space is arranged above the second space.

12. The robot cleaner station of claim 3, further comprising:
an accommodating space disposed within the housing, and configured to accommodate at least a portion of the robot cleaner; and
an air discharge unit configured to discharge air from the accommodating space,
wherein the air discharge unit comprises:
an air suction hole in communication with the accommodating space; and
an air discharge pipe configured to discharge air sucked in from the air suction hole, and
the air discharge pipe branches out to the left and right sides and is coupled to each of the pair of fitting portions.

13. A robot cleaner station comprising:
a housing;
a washing plate disposed below a mop of a robot cleaner and used to clean the mop;
a water supply connection pipe disposed within the housing and configured to supply fluid from an external water source to the washing plate;
a drain connection pipe disposed within the housing and used to discharge fluid passing through the washing plate; and
a flow connection module connected to the water supply connection pipe and the drain connection pipe,
wherein the water supply connection pipe and the drain connection pipe are pivotally connected to the flow path connection module.
